(19) United States
(12) Patent Application Publication
(10) Pub. No.: US 2010/0242606 A1
(43) Pub. Date: Sep. 30, 2010

(54) MEMS SENSOR, MEMS SENSOR MANUFACTURING METHOD, AND ELECTRONIC DEVICE

(75) Inventor: Kei KANEMOTO, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/731,494

(22) Filed: Mar. 25, 2010

(30) Foreign Application Priority Data
Mar. 26, 2009 (JP) 2009-075902
Mar. 16, 2010 (JP) 2010-058817

(51) Int. Cl. G01P 15/00; H01R 43/00

(52) U.S. Cl. 73/514.38; 29/825

(57) ABSTRACT

A MEMS sensor manufactured by processing a multi-layer stacked structure formed on a substrate, includes: a fixed frame portion formed in the substrate; a movable weight portion coupled to the fixed frame portion via an elastic deformable portion and having a hollow portion formed at the periphery; a fixed electrode portion protrudingly formed from the fixed frame portion toward the hollow portion; and a movable electrode portion moving integrally with the movable weight portion and facing the fixed electrode portion, wherein the movable weight portion includes a first movable weight portion formed of the multi-layer stacked structure and a second movable weight portion positioned below the first movable weight portion and formed of the material of the substrate.

### BACKGROUND

1. Technical Field

The present invention relates to a MEMS sensor (Micro Electro Mechanical Sensor), a MEMS sensor manufacturing method, and an electronic device.

2. Related Art

As a silicon MEMS acceleration sensor with a CMOS integrated circuit, for example, a reduction in size and cost of the MEMS sensor is rapidly progressing. The application and market of the MEMS sensor are expanding. In a main device form, an IC chip that converts a physical quantity into an electric signal and outputs the same is made into one package by a mounting process after a wafer process inmost cases. For achieving an extreme reduction in size and cost, a technique of integrally forming a sensor chip and an IC chip by a wafer process is required (refer to JP-A-2006-263902).

In a capacitive MEMS sensor (capacitive MEMS physical quantity sensor) that detects a physical quantity such as acceleration or pressure based on change in capacitance value of a capacitor configured by a movable electrode portion and a fixed electrode portion, the movable electrode portion is formed integrally with a movable weight portion. The movable electrode portion is displaced along with the displacement of the movable weight portion to change the gap or facing area between the movable electrode portion and the fixed electrode portion, which causes the movement of charge. The movement of charge is converted into an electric signal (voltage signal) by, for example, a C/V conversion circuit including a charge amplifier, so that the physical quantity is detected. In a typical MEMS sensor in which a movable electrode portion is integrated into a movable weight portion, the height of the movable electrode portion is the same as that of the movable weight portion (refer to FIGS. 4 and 5 in JP-A-2005-140792).

### SUMMARY

For example, in a capacitive MEMS acceleration sensor, a movable weight portion is fixed to a frame body with an elastic deformable portion (spring portion), a movable electrode portion as one electrode of a capacitor (capacitance) is connected to the movable weight portion, and a fixed electrode portion as the other electrode of the capacitor (capacitance) is disposed to face the movable electrode portion. When acceleration acts on the movable weight portion while the movable weight portion is in a resting state, force due to the acceleration acts on the movable weight portion to move the position of the movable weight portion. Along with the movement, for example, the gap between the movable electrode portion and the fixed electrode portion is changed to change the capacitance value of the capacitor (capacitance), so that the movement of charge occurs. By detecting the movement of charge as change in voltage, the change in capacitance value of the capacitor (capacitance) can be converted into a voltage. Based on the detected voltage, the value and direction of the acceleration applied to the movable weight portion can be determined.

As described above, there is a tendency for the MEMS sensor to be formed integrally with a CMOS IC or the like (refer to JP-A-2006-263902). In this case, it is advantageous to form the MEMS sensor by using a manufacturing process of the CMOS-IC using multi-layer wiring. That is, a main portion of the MEMS sensor is configured by a multi-layer wiring structure. In this case, the height of the electrode portion (movable electrode portion and fixed electrode portion) is the same as that of the movable weight portion (refer to JP-A-2005-140792).

For improving the detection sensitivity of the capacitive MEMS acceleration sensor, it is effective to increase a mass M of the movable weight portion. When the capacitive MEMS acceleration sensor is formed by using a process technique of a semiconductor device, a structure including the movable weight portion, the movable electrode portion, and the fixed electrode portion is formed of a stacked structure configured by stacking a plurality of films (insulating films, conductive material films, etc.). Therefore, when the mass M of the movable weight portion is intended to be increased, a height h of the stacked structure is inevitably increased. Accordingly, the height h of the movable electrode portion is also increased similarly.

On the other hand, the increase in the height h of the movable electrode portion increases the area of the movable electrode portion, whereby a damping coefficient D is increased. A main factor of damping is squeeze film damping (hereinafter simply referred to as damping). When the movable electrode portion vibrates, gas in a space interposed between the movable electrode portion and the fixed electrode portion moves vertically, for example. At that time, the viscosity of the gas causes an action to stop the movement of the movable electrode. The damping means this action. Specifically, the damping coefficient D increases with the cube of the height h of the movable electrode portion.

The damping coefficient D relates to a (spring-mass system) Q value that is mechanical characteristics inherent to a structure and relates to the Brownian noise that causes a reduction in S/N of the MEMS sensor. That is, force acts on a movable structure due to the Brownian motion of the gas between the electrode portions, which serves as the Brownian noise equivalent acceleration, for example.

As described above, the damping coefficient D increases with the cube of the height h of the movable electrode portion. Therefore, when the height h of the stacked structure is increased for increasing the mass M of the movable weight portion, the height h of the movable electrode portion also increases at the same time. As a result, for example, there arise problems that desired resonant characteristics cannot be obtained due to an extreme reduction in the Q value (spring-mass system), and that a reduction in S/N is caused due to an increase in the Brownian noise.

That is, in the capacitive MEMS sensor, the positive effect obtained by increasing the height h of the stacked structure to increase the mass M of the movable weight portion and the negative effect that the damping coefficient D in the movable electrode portion increases to reduce the Q value and increase the Brownian noise occur at the same time. That is, the degree of design freedom of the MEMS sensor is small. When the planar size, resonant frequency, Q value of the movable structure (including the movable weight portion and the movable electrode portion) are fixed to respective desired design values, there are no countermeasures actually for designing the structure other than compromising adjustment for some adjustable dimension parameters (specifically, for example, the height of the movable electrode portion, the lateral width of the movable electrode portion, the distance (gap) between the movable electrode portion and the fixed electrode portion, etc.).

According to some aspects of the invention, for example, the mass of the movable weight portion is increased without increasing the damping coefficient D, and the detection sensitivity can be remarkably improved. Moreover, for example, characteristics of the elastic deformable portion (spring portion) supporting the movable weight portion can be adjusted independently of the mass of the movable weight portion.

(1) A first aspect of the invention is directed to an MEMS sensor manufactured by processing a multi-layer stacked structure formed on a substrate, including: a fixed frame portion formed in the substrate; a movable weight portion coupled to the fixed frame portion via an elastic deformable portion and having a hollow portion formed at the periphery; a fixed electrode portion protrudingly formed from the fixed frame portion toward the hollow portion; and a movable electrode portion moving integrally with the movable weight portion and facing the fixed electrode portion, wherein the movable weight portion includes a first movable weight portion formed of the multi-layer stacked structure and a second movable weight portion positioned below the first movable weight portion and formed of the material of the substrate. In another embodiment, A MEMS sensor comprising: a support portion; a movable weight portion; a connection portion connecting the support portion and the movable weight portion, is possible an elastic deformation; a fixed electrode portion extending from the support portion; and a movable electrode portion extending from the movable weight portion and disposed opposed to the fixed electrode portion, wherein the movable weight portion includes a first movable weight portion and a second movable weight portion positioned below the first movable weight portion. The first movable weight portion is a laminated layer structure having a conductive layer and an insulated layer. The connection portion, the fixed electrode portion, and the movable electrode portion are formed by the use of the laminated layer structure. The insulated layer is embedded a plug, and the plug has specific gravity larger than that of the insulated layer. The second movable weight portion is a single layer substrate.

According to the first aspect of the invention, the movable weight portion is formed of the first movable weight portion and the second movable weight portion. The first movable weight portion is a weight portion formed of the stacked structure, while the second movable weight portion is a weight member formed of the material of the substrate. For example, the second movable weight portion is configured by processing the substrate such as of silicon serving as a base for forming the stacked structure. Therefore, when compared to the case of configuring the movable weight portion only by the first movable weight portion as the stacked structure, the mass M of the movable weight portion can be increased by the amount of the second movable weight portion formed of the material of the substrate.

By adopting a technique of increasing the mass M of the movable weight portion by using at least a part of the substrate, it is possible to adjust the mass M of the movable weight portion without influencing the height h of the stacked structure. That is, the height h of the stacked structure and the mass M of the movable weight portion can be adjusted independently of each other, so that the degree of design freedom of the MEMS sensor is improved.

(2) A second aspect of the invention is directed to the MEMS sensor according to the first aspect of the invention, wherein the elastic deformable portion includes a first elastic deformable portion formed of the multi-layer stacked structure and a second elastic deformable portion positioned below the first elastic deformable portion and formed of the material of the substrate, and the movable electrode portion is configured only by a first movable electrode portion formed of the multi-layer stacked structure.

According to the second aspect of the invention, the movable weight portion is formed of the first movable weight portion (stacked structure) and the second movable weight portion (substrate material). In the movable electrode portion, only the first movable electrode portion formed of the stacked structure is disposed (that is, the substrate material is not disposed below the first movable electrode portion). In the elastic deformable portion (spring portion), the first elastic deformable portion (stacked structure) and the second elastic deformable portion (substrate material) positioned below the first elastic deformable portion are disposed. That is, in the second aspect of the invention, the substrate material is disposed in the movable weight portion and the elastic deformable portion but not disposed in the movable electrode portion.

Only the first movable electrode portion formed of the stacked structure is disposed in the movable electrode portion, and the substrate material is not disposed below the first movable electrode portion. Therefore, the height of the movable electrode portion is different from that of the movable weight portion. In the second aspect of the invention, the mass M of the movable weight portion can be adjusted independently while maintaining the damping coefficient D, the facing area of the capacitor, or the like, relating to the height h1 of the movable electrode portion, at an optimum value, so that the MEMS sensor can be designed more freely.

For example, in the case where the planar size, resonant frequency, and Q value of the movable structure (including the movable weight portion and the movable electrode portion) are fixed to respective desired design values, when compared to the case of compromisingly adjusting adjustable dimension parameters (specifically, for example, the height of the movable electrode portion, the lateral width of the movable electrode portion, and the distance (gap) between the movable electrode portion and the fixed electrode portion) by a method in the related art, the detection sensitivity of the MEMS sensor can be remarkably improved in the case of adopting the structure of the second aspect of the invention.

By disposing the second elastic deformable portion formed of the substrate material in the elastic deformable portion, the movement of the elastic deformable portion (spring portion) in the vertical direction (direction perpendicular to the substrate) is restricted, for example. This provides an effect of reducing the possibility of causing unnecessary movement such as distortion in the movable weight portion when force due to acceleration is applied. By disposing the second elastic deformable portion, a mechanical spring constant in the elastic deformable portion (spring portion) is increased, while an electronic spring constant (spring constant due to the Coulomb force) becomes relatively small to be negligible. Therefore, an effect of facilitating the design of the elastic deformable portion (spring portion) can also be provided. That is, although the value of spring constant in the elastic deformable portion (spring portion) needs to fall within an appropriate range, an effective spring constant is not determined only by the mechanical spring constant of the elastic deformable portion (spring portion) but comprehensively determined also by considering an electronic spring constant due to static electricity force (the Coulomb force) acting between the fixed electrode and the movable electrode in the capacitance electrode portion. That is, an effective spring constant is determined by (mechanical spring constant—electronic spring constant). Accordingly, the equation of linear spring characteristics expressed by F=kX (F is force, k is a spring constant, and X is a displacement amount) is not established unless the electronic spring constant is designed so as to be sufficiently smaller than the mechanical spring constant, which is a design restriction. When the second elastic deformable portion is formed, a mechanical spring constant in an elastic member is increased due to the rigidity of the substrate material (for example, silicon), and an electronic spring constant (spring constant due to the Coulomb force) becomes relatively small so as to be negligible. Therefore, the design of the elastic deformable portion (spring portion) is facilitated. In this manner, with the effect of suppressing unnecessary deformation or increasing the mechanical spring constant in the elastic deformable portion (spring portion) for example, the detection sensitivity of the MEMS sensor is further improved.

(3) A third aspect of the invention is directed to the MEMS sensor according the first aspect of the invention, wherein the elastic deformable portion is configured only by a first elastic deformable portion formed of the multi-layer stacked structure, and the movable electrode portion is configured only by a first movable electrode portion formed of the multi-layer stacked structure.

In the third aspect of the invention, only the movable weight portion is formed of the first movable weight portion and the second movable weight portion. In the movable electrode portion and the elastic deformable portion, only the first movable electrode portion and the first elastic deformable portion formed of the stacked structure are respectively disposed, and the second movable electrode portion or the second elastic deformable portion formed of the substrate material is not disposed below the first movable electrode portion or the first elastic deformable portion. That is, in the third aspect of the invention, the substrate material is disposed only in the movable weight portion. In the movable electrode portion, only the stacked structure protrudes from the movable weight portion.

Since the substrate material is not disposed below the movable electrode portion, the height of the movable electrode portion is different from that of the movable weight portion. In the third aspect of the invention, the mass M of the movable weight portion can be adjusted independently while optimizing the damping coefficient D, the facing area of the capacitor, or the like, relating to the height h1 of the movable electrode portion, so that the MEMS sensor can be designed more freely. In the case where the planar size, resonant frequency, and Q value of the movable structure (including the movable weight portion and the movable electrode portion) are fixed to respective desired design values, when compared to the case of compromisingly adjusting adjustable dimension parameters (specifically, for example, the height of the movable electrode portion, the lateral width of the movable electrode portion, and the distance (gap) between the movable electrode portion and the fixed electrode portion) by a method in the related art, the detection sensitivity of the MEMS sensor can be remarkably improved in the case of adopting the structure of the third aspect of the invention.

The configuration of the third aspect of the invention can be formed by, for example, setting the width of the layout pattern of the electrode portion the same as that of the elastic deformable portion and, with the use of selective, isotropical etching of the substrate, removing the substrate below the electrode portion and the elastic deformable portion from the both side surfaces of the pattern by simultaneous etching, which is an advantage in view of a manufacturing process.

(4) A fourth aspect of the invention is directed to the MEMS sensor according to the first aspect of the invention, wherein the height of the movable electrode portion is smaller than that of the movable weight portion. In another embodiment, the thickness of added the first movable weight portion and the second movable weight portion is larger than that of the movable electrode portion.

Accordingly, for example, the height h2 of the movable weight portion can be increased to effectively increase the mass M of the movable weight portion, while the height h1 of the movable electrode portion can be adjusted to optimize the damping coefficient D of the movable electrode portion or the capacitance value C0 of the capacitor.

(5) A fifth aspect of the invention is directed to the MEMS sensor according to the first aspect of the invention, wherein the stacked structure forming the movable electrode portion includes a plurality of conductive layers that are in different layers, at least one inter-layer insulating layer, and a plug filled into a predetermined embedding groove pattern formed through each of one or more inter-layer insulating layers in the at least one inter-layer insulating layer.

With this configuration, a multi-layer stacked structure including a conductive material and an insulating material and having a close structure is formed. Accordingly, the mass M of the movable weight portion can be effectively increased. Moreover, an electrode portion can be assured in the stacked structure. Since the stacked structure can be formed by a manufacturing process of a semiconductor device (for example, CMOS process, bipolar CMOS hybrid IC process, etc.), the MEMS sensor can easily coexist with an integrated circuit portion on the same substrate.

(6) A sixth aspect of the invention is directed to the MEMS sensor according to the fifth aspect of the invention, wherein the plug formed in the respective layers includes a wall portion formed in a wall shape along a longitudinal direction in which the movable electrode portion is protrudingly formed.

A typical plug for establishing electrical continuity is embedded in a circular through hole, for example. In the sixth aspect of the invention, however, a plug material is embedded in a through hole pattern extending along a protruding direction (longitudinal direction) of the movable electrode portion, whereby the wall-shaped plug (wall portion) is formed. Accordingly, the movable electrode portion of the capacitor having a desired facing area can be realized with the stacked plug.

The plug material (conductive material, which is generally metal such as tungsten) is greater in specific gravity than the material of the insulating layer. Accordingly, in the movable weight portion, the total amount of the plug material can be increased by forming the wall-shaped plug structure. Accordingly, the mass M of the movable weight portion can be easily increased. Moreover, by forming the wall-shaped plug structure, the wall portion of the plug can function as an electrode surface of a capacitor having a predetermined facing area. When an electrically-isolated, wall-shaped electrode portion (having only a function of adjusting the mass) is also extended in a direction (for example, direction perpendicular to the longitudinal direction) different from the longitudinal direction, the mass of the movable weight portion can be further increased effectively, and the adjustment of the mass is facilitated.

(7) A seventh aspect of the invention is directed to the MEMS sensor according to the sixth aspect of the invention, wherein the wall portion formed in the movable electrode portion has a first wall portion and a second wall portion that are electrically independent of each other.

With the use of this structure, two capacitors C1 and C2 that are electrically independent of each other can be configured without laboring while saving space. For example, when the first wall portion disposed on one side surface side of one movable electrode portion faces the first fixed electrode portion, and the second wall portion disposed on the other side surface side of the movable electrode portion faces the second fixed electrode portion, the two capacitors C1 and C2 can be compactly formed.

(8) An eighth aspect of the invention is directed to the MEMS sensor according to the first aspect of the invention, wherein a recess is formed on the back surface of the substrate. In another embodiment, the support portion is formed on a base portion, the base portion is used the same material as the second movable weight portion, a through hole is formed between the base portion and the second movable weight portion. A junction portion is formed between the second movable weight portion and the base portion, connect the second movable weight portion and the base portion, the connection portion is formed on the junction portion. The thickness of at least partly the base portion is larger than that of the second movable weight portion.

In the eighth aspect of the invention, the recess is formed in advance on the back surface of the substrate before forming the stacked structure. When the depth of the recess is adjusted, the thickness of the second movable weight portion left in the movable weight portion can be adjusted. As a result, the mass of the movable weight portion can be adjusted. Moreover, by forming the recess in advance, a level difference is formed on the substrate. Therefore, a space can be assured below the movable weight portion, which can prevent the movable weight portion from being in contact with a placing surface.

(9) A ninth aspect of the invention is directed to the MEMS sensor according to the fifth aspect of the invention, further including an integrated circuit portion formed on the substrate while being adjacent to the stacked structure formed on the substrate, wherein the plurality of conductive layers, the at least one inter-layer insulating layer, and the plug formed through each of one or more inter-layer insulating layers of the stacked structure are manufactured by using a manufacturing process of the integrated circuit portion. In another embodiment, an integrated circuit portion formed adjacent to the support portion.

As described above, since the stacked structure of the movable weight portion is suitable for a CMOS process or the like, the MEMS sensor can be mounted on the same substrate together with the integrated circuit portion. This makes it possible to reduce a manufacturing cost compared to the case of manufacturing and assembling the respective ones in different processes. Further, the CMOS integrated circuit portion and the MEMS structure are formed monolithically, so that the wiring distance can be shortened. Therefore, it can be expected that a loss component due to the routing of the wiring will be reduced, and that resistance to external noise will be improved.

(10) A tenth aspect of the invention is directed to a method for manufacturing an MEMS sensor, including: forming a multi-layer stacked structure on a substrate; patterning the stacked structure by anisotropic etching to form a first hollow portion that serves as an opening to expose the surface of the substrate and defining, by the first hollow portion, a fixed frame portion, an elastic deformable portion, a movable weight portion coupled to the fixed frame portion via the elastic deformable portion, a movable electrode portion protruding from the movable weight portion toward the first hollow portion, and a fixed electrode portion protruding from the fixed frame portion toward the first hollow portion and facing the movable electrode portion; and selectively processing the substrate to form a second hollow portion, wherein the second hollow portion is formed at least below the movable electrode portion and the fixed electrode portion. In another embodiment, A MEMS sensor manufacturing method for a MEMS sensor having a support portion; a movable weight portion; a connection portion connecting the support portion and the movable weight portion, is possible an elastic deformation; a fixed electrode portion extending from the support portion; and a movable electrode portion extending from the movable weight portion and disposed opposed to the fixed electrode portion, comprising: first process forming a laminated layer structure on a first plane of a substrate; second process forming a hole penetrating from a top layer of the laminated layer structure to the substrate, by anisotropic etching; third process removing the substrate positioned below the fixed electrode portion and the movable electrode portion, by isotropically etching.

According to the manufacturing method of the tenth aspect of the invention, anisotropic etching of the stacked structure and selective processing of the substrate (selective patterning of the substrate) are combined, so that the MEMS sensor having the movable weight portion that is coupled to the fixed frame portion via the elastic deformable portion and has the hollow portion formed at the periphery can be manufactured effectively by using a semiconductor manufacturing technique. Moreover, the second hollow portion is formed below the movable electrode portion and the fixed electrode portion, while the substrate is left below the movable weight portion. With this configuration, the height of the movable weight portion can be controlled independently of the height of the movable electrode portion formed of the stacked structure.

As an anisotropic etching method for the stacked structure, for example, there is a method of performing dry etching using a mixed gas of CF₄, CHF₃, and the like.

As a method of selectively processing (selectively patterning) the substrate, for example, a method can be adopted in which in the substrate before forming the stacked structure (in a state where a surface insulating film is formed), selective etching (for example, wet anisotropic etching due to alkali etching using KOH or the like, or dry anisotropic etching using an anisotropic etching gas) is applied from the back surface of the substrate to remove a part of the substrate, so that the second hollow portion is formed in the substrate.

Moreover, the following method can be adopted, for example. After forming the stacked structure, the stacked structure is selectively patterned to form the first hollow portion. An etchant for anisotropic etching is introduced from the first hollow portion to anisotropically etch the substrate, so that a through hole in communication with the first hollow portion is formed. Next, an etchant for isotropic etching is introduced through the through hole to isotropically etch the substrate positioned below the first hollow portion from the side surface portion, so that the second hollow portion is formed. The above-described process is an example, and the method is not restricted thereto. For the processing of the substrate, for example, mechanical scraping can be used, or a technique of forming the recess utilizing a bonding technique for substrates can also be used.

(11) An eleventh aspect of the invention is directed to the method for manufacturing the MEMS sensor according to the tenth aspect of the invention, wherein upon selectively processing the substrate, an etchant for anisotropic etching is introduced via the first hollow portion to form a through hole through the substrate, and an etchant for isotropic etching is introduced via the through hole to isotropically etch the substrate, so that the second hollow portion is formed at least below the movable electrode portion and the fixed electrode portion.

In the eleventh aspect of the invention, for selectively processing the substrate positioned below the movable electrode portion and the fixed electrode portion, isotropic etching is used. According to the manufacturing method of the eleventh aspect of the invention, anisotropic etching of the stacked structure and isotropic etching of the substrate are combined, so that the MEMS sensor having the movable weight portion that is coupled to the fixed frame portion via the elastic deformable portion and has the hollow portion formed at the periphery can be manufactured effectively by using a semiconductor manufacturing technique. Moreover, the second hollow portion is formed below the movable electrode portion and the fixed electrode portion, while the substrate is left below the movable weight portion. With this configuration, the height of the movable weight portion can be controlled independently of the height of the movable electrode portion formed of the stacked structure.

When the substrate is isotropically etched, the substrate positioned below the elastic deformable portion can also be removed selectively. For example, a method can be adopted in which the width of the layout pattern of the electrode portion is set to the same as that of the elastic deformable portion, and the substrate below the electrode portion (movable electrode portion and fixed electrode portion) and the elastic deformable portion is removed by isotropic etching simultaneously from both side surface sides of the pattern. This example provides an effect that the substrate can be processed in a relatively short time by using isotropic etching that is a typical manufacturing method of a semiconductor device.

Moreover, when the substrate below the elastic deformable portion is not completely removed by isotropic etching, the substrate material can be left below the elastic deformable portion. For example, when the width of the layout pattern of the elastic deformable portion is set broader than that of the electrode portion, and the substrate below the electrode portion (movable electrode portion and fixed electrode portion) and the elastic deformable portion is isotropically etched simultaneously from the both side surface sides of the pattern, the substrate below the electrode portion is completely removed after a predetermined time. However, the substrate is left below the elastic deformable portion. When the etching is stopped in this state, the substrate below the electrode portion can be completely removed while leaving the substrate material below the elastic deformable portion.

(12) A twelfth aspect of the invention is directed to the method for manufacturing the MEMS sensor according to the tenth aspect of the invention, further including forming a recess on the back surface of the substrate, wherein in the isotropic etching, the second hollow portion is communicated with the recess. Further comprising forming a recess on a second plane as the opposite side of the first plane.

By doing this, even when the thickness of the substrate is great, the height of the second movable weight portion can be adjusted with the depth of the recess, so that a desired mass can be obtained easily.

(13) A thirteenth aspect of the invention is directed to the method for manufacturing the MEMS sensor according to the tenth aspect of the invention, wherein selectively processing the substrate to form the second hollow portion includes performing anisotropic etching from the back surface side of the substrate.

That is, a method can be adopted in which selective etching (for example, wet anisotropic etching due to alkali etching using KOH or the like, or dry anisotropic etching using an anisotropic etching gas, and the combination of both is also possible) is applied from the back surface of the substrate to remove part of the substrate, so that the second hollow portion is formed in the substrate.

(14) A fourteenth aspect of the invention is directed to the MEMS sensor according to the first aspect of the invention, an electronic device comprising the MEMS sensor.

According to this structure, it is able to improve detection sensitivity by the MEMS sensor.

### BRIEF DESCRIPTION OF THE DRAWINGS

The invention will be described with reference to the accompanying drawings, wherein like numbers reference like elements.

FIG. 1 shows a planar shape and a cross-sectional structure of an exemplary MEMS sensor (capacitive MEMS acceleration sensor having a second movable weight portion formed of a part of a silicon substrate) of the invention.

FIG. 2 is a block diagram of an acceleration sensor module according to an embodiment.

FIGS. 3A to 3C explain a configuration and operation of a C/V conversion circuit.

FIG. 4 is a schematic view of the acceleration sensor module having mounted thereon an acceleration sensor according to an embodiment to which the MEMS sensor of the invention is applied.

FIG. 5 shows a planar shape of a capacitive MEMS acceleration sensor.

FIG. 6 is a cross-sectional view of the capacitive MEMS acceleration sensor shown in FIG. 5 taken along line A-A.

FIG. 7 is a cross-sectional view of the capacitive MEMS acceleration sensor shown in FIG. 5 taken along line B-B.

FIG. 8 shows a cross-sectional structure of an integrated circuit portion.

FIGS. 9A and 9B show a first manufacturing step of a method for manufacturing an acceleration sensor module.

FIGS. 10A and 10B show a second manufacturing step of the method for manufacturing the acceleration sensor module.

FIGS. 11A and 11B show a third manufacturing step of the method for manufacturing the acceleration sensor module.

FIGS. 12A and 12B explain isotropic etching of a substrate.

FIG. 13 shows a fourth manufacturing step of the method for manufacturing the acceleration sensor module.

FIG. 14 is a cross-sectional view of conductive layers and plugs.

FIG. 15 shows a planar shape and a cross-sectional structure of another exemplary MEMS sensor of the invention.

FIGS. 16A and 16B explain an exemplary effect of a second elastic deformable portion.

FIG. 17 shows a planar shape and a cross-sectional structure of still another exemplary MEMS sensor of the invention.

FIGS. 18A to 18C show a structure example for giving independent potentials for respective two wall-shaped electrode portions in a movable electrode portion.

FIG. 19 explains dimensions of a movable electrode portion and a fixed electrode portion relating to a damping coefficient and the Brownian noise.

FIGS. 20A to 20C show another exemplary method for manufacturing the MEMS sensor.

FIG. 21 shows still another exemplary method for manufacturing the MEMS sensor.

### DESCRIPTION OF EXEMPLARY EMBODIMENTS

Hereinafter, preferred embodiments of the invention will be described in detail. The embodiments described below are not intended to unreasonably limit the content of the invention set forth in the claims. Also, not all of the configurations described in the embodiments are essential as solving means.

### First Embodiment

In a first embodiment, an exemplary structure or the like of an electrostatic capacitive MEMS acceleration sensor will be described.

### Exemplary Planar Shape, Cross-Sectional Structure, and Feature Point of MEMS Acceleration Sensor

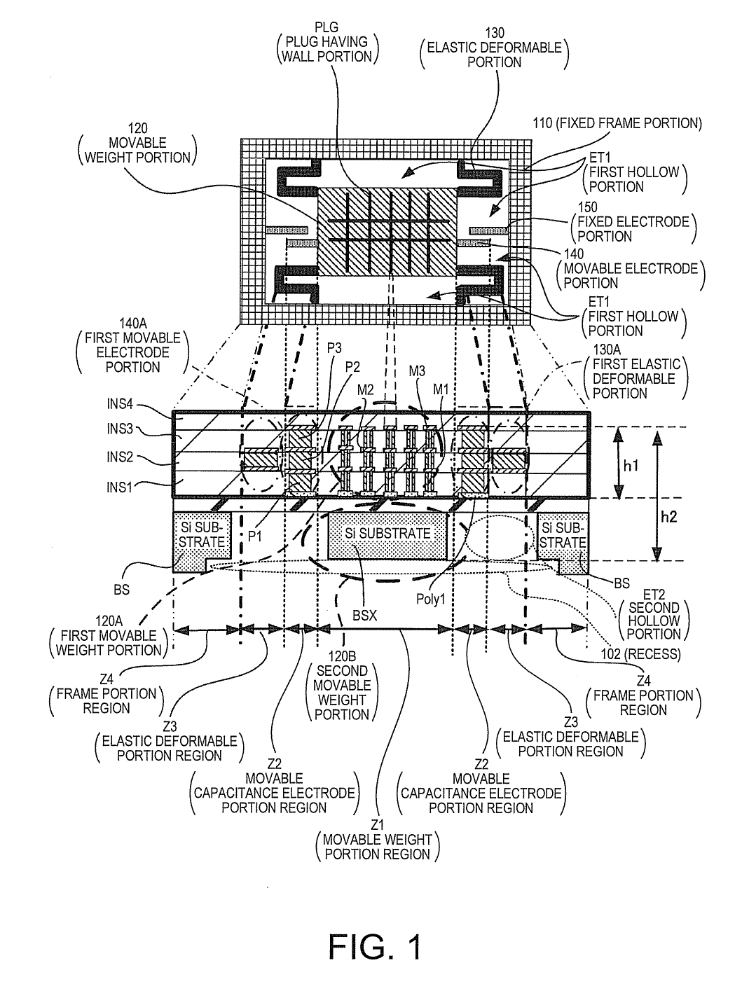

FIG. 1 shows a planar shape and a cross-sectional structure of an exemplary MEMS sensor (capacitive MEMS acceleration sensor having a second movable weight portion formed of a part of a silicon substrate) of the invention.

As shown in the upper side of FIG. 1, the capacitive MEMS acceleration sensor has a movable weight portion 120 including a stacked structure (having a plurality of insulating layers and plugs PLG having wall portions extending in a predetermined direction) formed by using a semiconductor manufacturing process, elastic deformable portions (connection portion) 130, a fixed frame portion (support portion) 110 formed of a silicon substrate, movable electrode portions 140, and fixed electrode portions 150. The movable electrode portion 140 and the fixed electrode portion 150 are arranged to face each other, so that the electrode portions constitute a capacitor (parallel-plate type capacitance). The movable electrode portions 140 are configured integrally with the movable weight portion 120. When the movable weight portion 120 vibrates in response to force due to acceleration, the movable electrode portions 140 vibrate similarly. This changes a gap d of the capacitor to change the capacitance value of the capacitor. Along with the change, the movement of charge occurs. A minute current caused by the charge movement is amplified by a charge amplifier, so that the value of the acceleration applied to the movable weight portion 120 can be detected.

In the lower side of FIG. 1, cross-sectional structures corresponding to the respective regions of the capacitive MEMS acceleration sensor shown in the upper side of FIG. 1 are shown. In the cross-sectional structures, each of the portions formed of the stacked structure is preceded by an ordinal number “first”, while each of the portions formed of the substrate is preceded by an ordinal number “second” (the same applies to the other drawings), for the convenience of description.

In the drawing, Z1 denotes a movable weight portion region, Z2 denotes movable capacitance electrode portion regions, Z3 denotes elastic deformable portion regions, and Z4 denotes fixed frame portion regions. The stacked structure is formed on a silicon substrate BS. The stacked structure (indicated by an enclosing heavy line in the lower side of FIG. 1) includes a plurality of insulating layers INS1 to INS4 that are indifferent layers, a first-layer metal M1, a second-layer metal M2, a third-layer metal M3, and a first-layer polysilicon Polyl.

In the movable weight portion region Z1, a part BSX of the silicon substrate (for example, formed as a result of processing the silicon substrate BS by etching) is present below the stacked structure (more specifically, right below at least the central portion of the stacked structure). The part BSX of the silicon substrate constitutes a second movable weight portion 120B. The stacked structure formed by closely stacking the plugs PLG having wall portions and the plurality of insulating layers constitutes a first movable weight portion 120A.

In the movable capacitance electrode portion region Z2 (and a fixed electrode portion region), the silicon substrate (that is, a second movable electrode portion including the substrate material) is not disposed. Instead, a second hollow portion ET2 is formed by selectively etching the silicon substrate. In the case of FIG. 1, a recess 102 is previously formed on the back surface of the silicon substrate BS by etching. The recess 102 and the second hollow portion ET2 are communicated with each other.

According to the capacitive MEMS acceleration sensor of the embodiment, the movable weight portion 120 is formed of the first movable weight portion 120A formed of the stacked structure and the second movable weight portion 120B including the substrate material. As described above, the second movable weight portion 120B is a weight member formed of the material of the substrate (or, including the substrate material). The weight member is configured by, for example, processing a substrate as a base for forming the stacked structure. Therefore, when compared to the case of configuring the movable weight portion 120 only by the first movable weight portion 120A as the stacked structure, an entire mass M of the movable weight portion 120 can be increased by the amount of the second movable weight portion 120B formed of the substrate material.

By adopting a technique of increasing the mass M of the movable weight portion 120 by using at least a part of the substrate, the mass M of the movable weight portion 120 can be adjusted without influencing a height h1 of the stacked structure (that is, a height of the movable electrode portion 140). That is, the height h1 of the movable electrode portion 140 and a height h2 of the movable weight portion 120 can be controlled independently of each other. Therefore, the mass of the movable weight portion is increased without increasing the damping coefficient D, and the detection sensitivity can be remarkably improved.

In the embodiment, the movable weight portion 120 is formed of the first movable weight portion 120A and the second movable weight portion 120B. In the movable electrode portion 140, on the other hand, the second movable electrode portion formed of the substrate material is not disposed, and only a first movable electrode portion 140A formed of the stacked structure is protruded from the movable weight portion 120. Therefore, the height h1 of the movable electrode portion 140 is different from the height h2 of the movable weight portion 120. Accordingly, the damping coefficient D or the facing area of the electrodes of the capacitor that relates to the height h1 of the movable electrode portion 140 and the mass M of the movable weight portion can be adjusted independently of each other. Therefore, the capacitive MEMS acceleration sensor can be designed more freely. In the case where the planar size, resonant frequency, and Q value of the movable structure (including the movable weight portion and the movable electrode portion) are fixed to respective desired design values, when compared to the case of compromisingly adjusting adjustable dimension parameters (specifically, for example, the height h1 of the movable electrode portion 140, a lateral width w of the movable electrode portion 140, and the distance (gap) d0 between the movable electrode portion 140 and the fixed electrode portion 150) by a method in the related art, the detection sensitivity of the capacitive MEMS acceleration sensor can be remarkably improved in the case of adopting the structure of the embodiment.

In the embodiment, the height h1 of the movable electrode portion 140 is set lower than the height h2 of the movable weight portion 120. Accordingly, for example, the height h2 of the movable weight portion 120 can be increased to effectively increase the mass M of the movable weight portion 120. On the other hand, the height h2 of the movable electrode portion 140 can be adjusted to optimize the damping coefficient D of the movable electrode portion 140 or a capacitance value C0 of the capacitor.

In the embodiment, the stacked structure forming the movable electrode portion 140 includes the plurality of conductive layers that are in different layers, at least one of the inter-layer insulating layers INS2 to INS4, and the plug PLG that is filled into a predetermined embedding groove pattern formed through each of one or more inter-layer insulating layers in at least one of the inter-layer insulating layers INS2 and INS3. This forms a multi-layer stacked structure including a conductive material and an insulating material and having a close structure. Therefore, the mass M of the movable weight portion 120 can be effectively increased. Moreover, in the stacked structure, the electrode portion of the capacitor that has a predetermined facing area can be assured. Since the stacked structure can be formed by a manufacturing process of a semiconductor device (for example, CMOS process, bipolar CMOS hybrid IC process, etc.), the MEMS sensor can easily coexist with an integrated circuit portion on the same substrate.

In the embodiment, the plug formed of a conductive material filled into the through hole pattern in each layer includes the wall portion formed in a wall shape along a longitudinal direction in which the movable electrode portion 140 is protrudingly formed. In the embodiment, however, a plug material is embedded in the through hole pattern extending along the longitudinal direction, whereby the wall-shaped plug is formed. The plug material (conductive material, which is generally metal such as tungsten) is greater in specific gravity than the material of the insulating layers INS1 to INS4. By forming the wall-shaped plug structure, the total amount of the plug material can be increased. Accordingly, the mass M of the movable weight portion 120 can be easily increased (however, this is not restrictive, and it is also possible to configure the stacked structure in the movable weight portion only by the plurality of insulating layers).

As shown in the upper side of FIG. 1, in the stacked structure in the movable weight portion region Z1, the plug may also be extended in a direction (vertical direction) perpendicular to the longitudinal direction to arrange the plugs in a cross shape, so that the mass M of the movable weight portion 120 can be further increased effectively.

By forming the wall-shaped plug structure, the wall portion of plug (wall-shaped side surface portion) of the electrode portion (the movable electrode portion 140 and the fixed electrode portion 150) of the capacitor can function as an electrode surface of the capacitor having a predetermined facing area (that is, having a desired capacitance value).

On the back surface of the substrate BS (base portion), the recess 102 is previously disposed, so that the thickness of the substrate can be adjusted. In this case, when the depth of the recess is adjusted, the thickness of the second movable weight portion 120B (substrate BSX) left in the movable weight portion can be adjusted. As a result, the mass of the movable weight portion can be adjusted. By forming the recess 102 in advance, a level difference is formed on the substrate. Therefore, a space can be assured below the movable weight portion, which can prevent the movable weight portion from being in contact with a placing surface.

### Configuration Example of Acceleration Sensor Module and C/V Conversion Circuit

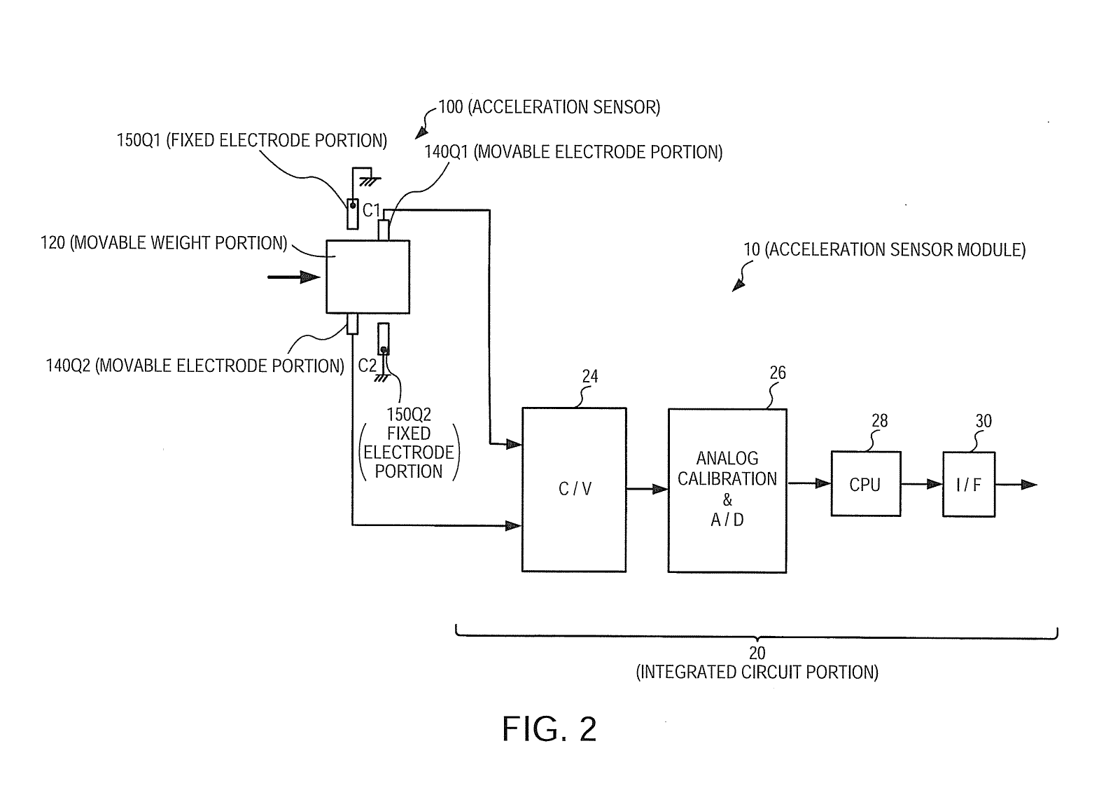

FIG. 2 is a block diagram of an acceleration sensor module 10 of the embodiment. An acceleration sensor 100 has at least two movable and fixed electrode pairs. In FIG. 2, the acceleration sensor 100 has a movable electrode portion 140Q1, a movable electrode portion 140Q2, a fixed electrode portion 150Q1, and a fixed electrode portion 150Q2. The movable electrode portion 140Q1 and the fixed electrode portion 150Q1 constitute a capacitor C1. The movable electrode portion 140Q2 and the fixed electrode portion 150Q2 constitute a capacitor C2. The potential of one electrode (for example, fixed electrode portion) of each of the capacitors C1 and C2 is fixed to a reference potential (for example, ground potential). Here, the potential of the movable electrode portion may be fixed to a ground potential.

An integrated circuit portion 20 formed by, for example, a CMOS process includes, for example, a C/V conversion circuit 24, an analog calibration and A/D conversion circuit unit 26, a central processing unit (CPU) 28, and an interface (I/F) circuit 30. However, this configuration is an example and is not restrictive. For example, the CPU 28 can be replaced by control logic, and the A/D conversion circuit can be disposed at the output stage of the C/V conversion circuit 24. The analog/digital conversion circuit and the CPU may be disposed by using an integrated circuit different from the integrated circuit portion 20 depending on the case.

When acceleration acts on the movable weight portion 120 in a state where the movable weight portion 120 is stopped, force due to the acceleration acts on the movable weight portion 120 to change each of gaps of the movable and fixed electrode pairs. When it is assumed that the movable weight portion 120 is moved in a direction of arrow in FIG. 2, the gap between the movable electrode portion 140Q1 and the fixed electrode portion 150Q1 is increased, and the gap between the movable electrode portion 140Q2 and the fixed electrode portion 150Q2 is decreased. Since the gap and the capacitance are in an inverse relation, the capacitance value C1 of the capacitor C1 formed of the movable electrode portion 140Q1 and the fixed electrode portion 150Q1 becomes small, and the capacitance value C2 of the capacitor C2 formed of the movable electrode portion 140Q2 and the fixed electrode portion 150Q2 becomes great.

Along with the change in capacitance values of the capacitors C1 and C2, the movement of charge occurs. The C/V conversion circuit 24 has a charge amplifier using, for example, a switched capacitor. The charge amplifier converts a minute current signal caused by the movement of charge into a voltage signal by sampling operation and integration (amplification) operation. A voltage signal (that is, a physical quantity signal detected by the physical quantity sensor) output from the C/V conversion circuit 24 is subjected to calibration processing (for example, adjustment of phase or signal amplitude, and low-pass filter processing may be further performed) by the analog calibration and A/D conversion circuit unit 26, and thereafter converted from an analog signal to a digital signal.

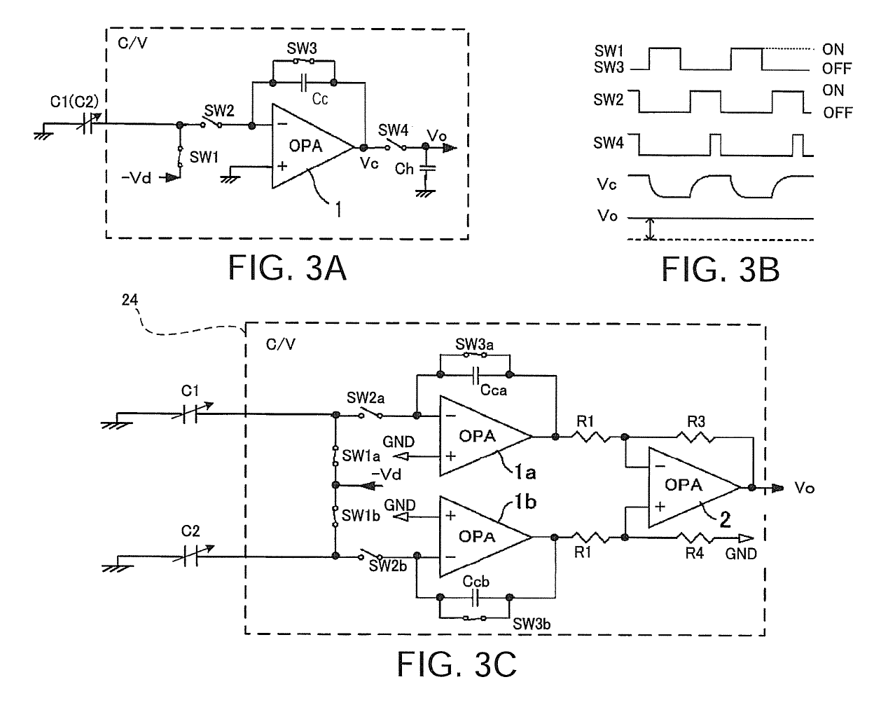

By using FIGS. 3A to 3C, the configuration and operation of the C/V conversion circuit 24 will be described. FIG. 3A shows the basic configuration of a charge amplifier using a switched capacitor. FIG. 3B shows voltage waveforms of respective parts of the charge amplifier shown in FIG. 3A.

As shown in FIG. 3A, the C/V conversion circuit basically has a first switch SW1 and a second switch SW2 (constituting a switched capacitor of an input part together with a variable capacitance C1 (or C2)), an operational amplifier OPA1, a feedback capacitance (integral capacitance) Cc, a third switch SW3 for resetting the feedback capacitance Cc, a fourth switch SW4 for sampling an output voltage Vc of the operational amplifier OPA1, and a holding capacitance Ch.

As shown in FIG. 3B, the on/off of the first switch SW1 and the third switch SW3 is controlled by a first clock of the same phase, and the on/off of the second switch SW2 is controlled by a second clock having an opposite phase from the first clock. The fourth switch SW4 is briefly turned on at the end of a period in which the second switch SW2 is turned on. When the first switch SW1 is turned on, a predetermined voltage Vd is applied to both ends of the variable capacitance C1 (C2), so that charge is accumulated in the variable capacitance C1 (C2). In this case, the feedback capacitance Cc is in a reset state (state of being short-circuited between both ends) because the third switch is in the on state. Next, the first switch SW1 and the third switch SW3 are turned off, and the second switch SW2 is turned on, the both ends of the variable capacitance C1 (C2) are at a ground potential. Therefore, the charge accumulated in the variable capacitance C1 (C2) moves toward the operational amplifier OPA1. In this case, since the charge amount is stored, a relation of Vd·C1 (C2)=Vc·Cc is established. Accordingly, the output voltage Vc of the operational amplifier OPA1 is expressed by (C1/Cc)·Vd. That is, the gain of the charge amplifier is determined by the ratio between the capacitance value of the variable capacitance C1 (or C2) and the capacitance value of the feedback capacitance Cc. Next, when the fourth switch (sampling switch) SW4 is turned on, the output voltage Vc of the operational amplifier OPA1 is held by the holding capacitance Ch. Vo denotes the held voltage. The voltage V0 serves as the output voltage of the charge amplifier.

As shown in FIG. 2, the C/V conversion circuit 24 actually receives differential signals from the two capacitors C1 and C2. In this case, as the C/V conversion circuit 24, a differential charge amplifier shown in FIG. 3C can be used, for example. In the charge amplifier shown in FIG. 3C, in the input stage, a first switched-capacitor amplifier (SW1a, SW2a, OPA1a, Cca, and SW3a) for amplifying a signal from the variable capacitance C1 and a second switched-capacitor amplifier (SW1b, SW2b, OPA1b, Ccb, and SW3b) for amplifying a signal from the variable capacitance C2 are disposed. Respective output signals (differential signals) of the operational amplifiers OPA1a and OPA1b are input to a differential amplifier (OPA2 and resistances R1 to R4) disposed in the output stage. As a result, the output signal Vo amplified is output from the operational amplifier OPA2. The use of the differential amplifier provides an effect that base noises can be removed.

The above-described configuration of the C/V conversion circuit is an example, and the C/V conversion circuit is not restricted to the configuration. In FIG. 2, only the two movable and fixed electrode pairs are shown for the convenience of description. However, this is not restrictive. The number of electrode pairs can be increased corresponding to a required capacitance value. Actually, from several tens to several hundreds of electrode pairs are disposed, for example. In the above example, although the gap between the electrodes is changed in the capacitors C1 and C2 to change the capacitance of each of the capacitors, this is not restrictive. A configuration can be adopted in which the facing areas of two movable electrodes with respect to one reference electrode are changed to change the capacitances of the two capacitors C1 and C2 (this configuration is effective when acceleration acting on, for example, a Z-axis direction (direction perpendicular to the substrate) is detected).

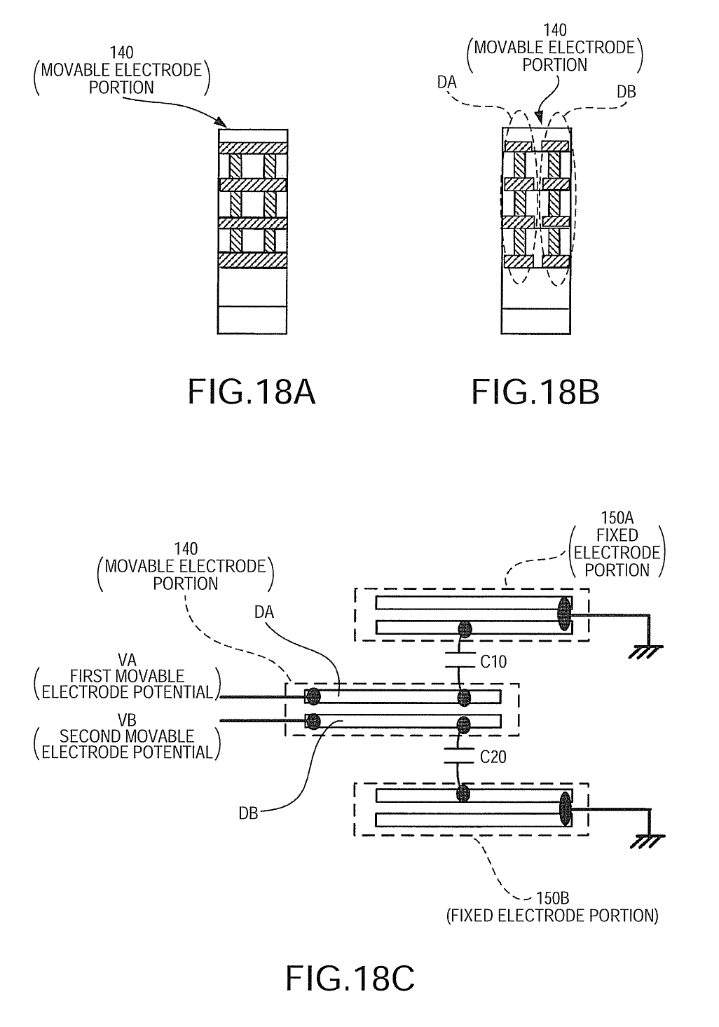

In the case of adopting the configuration in FIG. 2, it is necessary to take out signals electrically independent of each other from the movable electrode portions 140Q1 and 140Q2 (that is, it is necessary that respective potentials of the two movable electrode portions 140Q1 and 140Q2 should be independent of each other). This configuration can be realized by adopting a structure shown in FIGS. 18A to 18C, for example.

FIGS. 18A to 18C show a structure example for giving independent potentials to two wall-shaped electrode portions in a movable electrode portion. FIG. 18A shows a wall-shaped electrode structure (electrode structure of wall portion) in the movable electrode portion 140. FIG. 18B shows the wall-shaped electrode structure shown in FIG. 18A as viewed from a perspective perpendicular to the perspective of FIG. 18A. As shown in FIG. 18B, two wall-shaped electrode portions DA and DB, which are electrically independent of each other (that is, they are not connected to each other), are formed in the movable electrode portion 140. Accordingly, when the movable electrode portion 140 and the fixed electrode portions 150 are arranged as shown in FIG. 18C for example, the two capacitors C1 and C2 that are electrically independent of each other can be configured without laboring while saving space. VA and VB denote respective potentials of the two capacitors C1 and C2.

### Second Embodiment

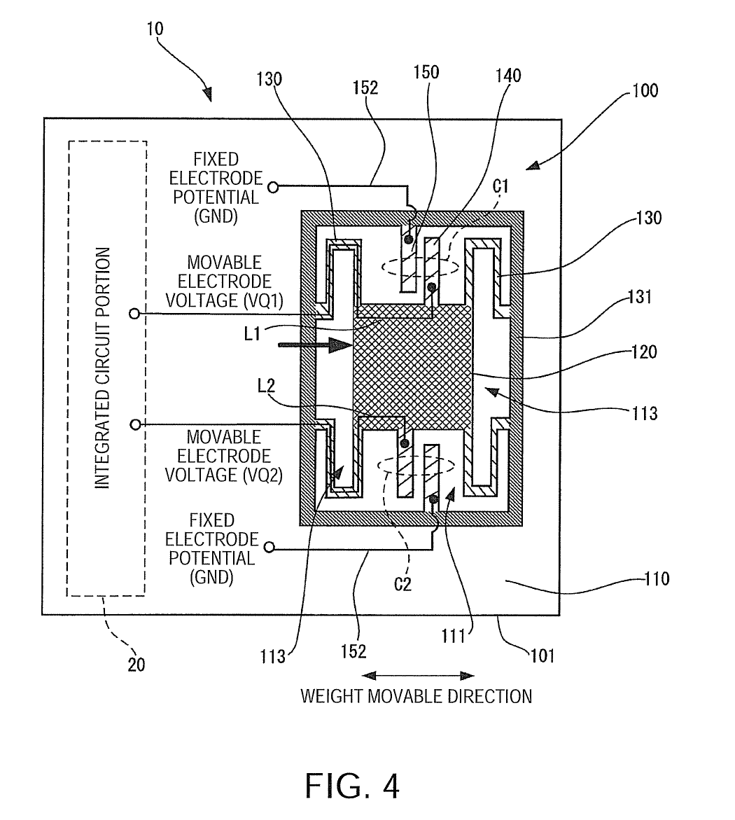

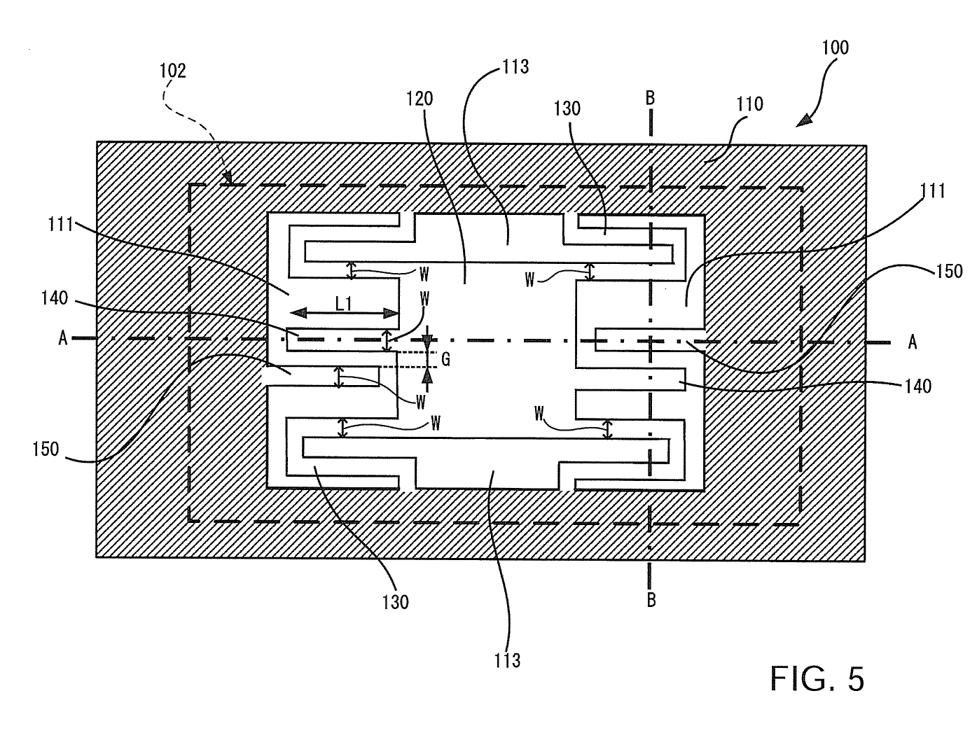

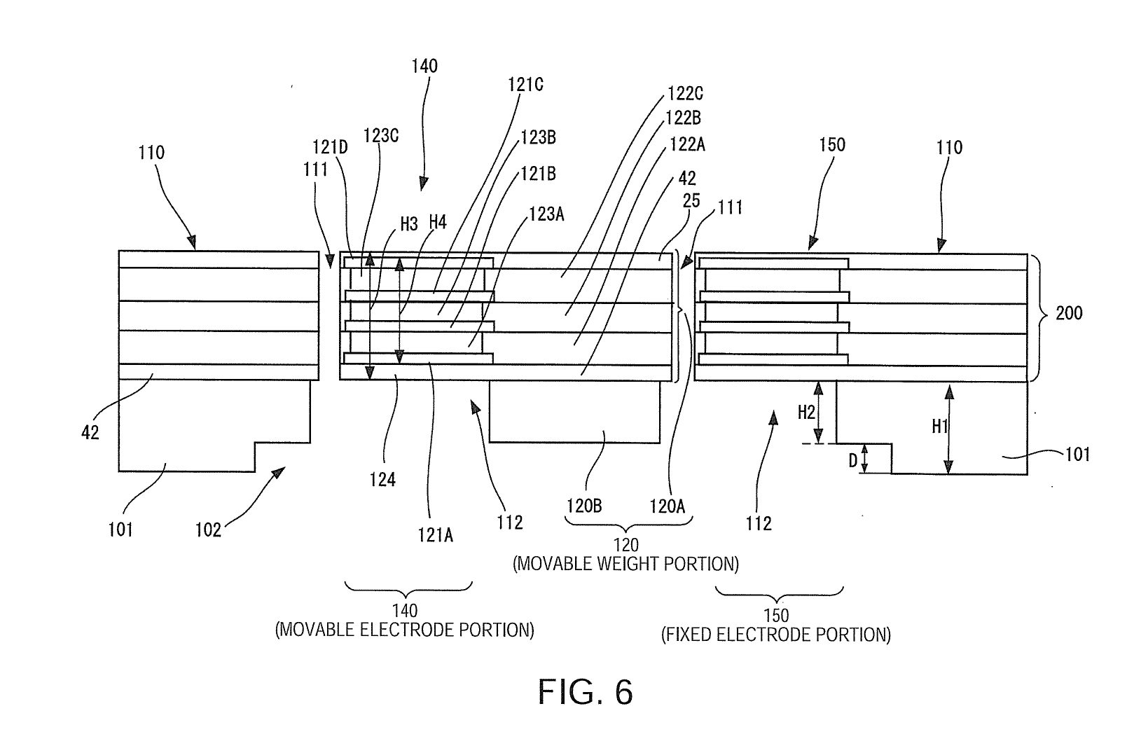

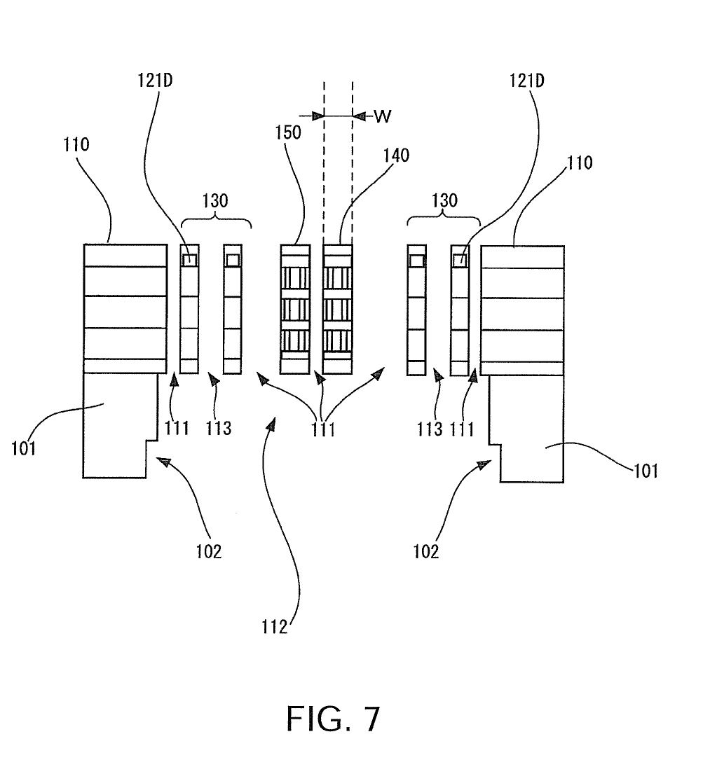

In a second embodiment, the structure of the capacitive MEMS acceleration sensor will be specifically described. In the embodiment, a sensor chip and an IC chip are integrally formed by a wafer process. FIG. 4 is a schematic view of the acceleration sensor module 10 having mounted thereon the acceleration sensor 100 according to the embodiment to which the MEMS sensor of the invention is applied. FIG. 5 shows a planar shape of the capacitive MEMS acceleration sensor. FIG. 6 is a cross-sectional view of the capacitive MEMS acceleration sensor shown in FIG. 5 taken along line A-A. FIG. 7 is a cross-sectional view of the capacitive MEMS acceleration sensor shown in FIG. 5 taken along line B-B. As shown in FIG. 4, in the acceleration sensor module 10, the integrated circuit portion 20 is mounted together with the acceleration sensor 100 on a substrate, for example, a silicon substrate 101. The acceleration sensor 100 is formed also by using manufacturing process steps of the integrated circuit portion 20.

On the back surface of the silicon substrate 101, the recess 102 is formed over a region indicated by a broken line in FIG. 5, for example, and in a depth D as shown in FIG. 6 which is the A-A cross section of FIG. 5. The acceleration sensor 100 is arranged in a region facing the recess 102 of the silicon substrate 101.

As shown in FIG. 4, the acceleration sensor 100 has the fixed frame portion 110 formed in the silicon substrate 101, the movable weight portion 120 coupled to the fixed frame portion 110 via the elastic deformable portions (spring portions) 130 and having hollow portions 111 (first hollow portions) formed at the periphery, the fixed electrode portions 150 each protrudingly formed from the fixed frame portion 110 toward the hollow portion 111, and the movable electrode portions 140 moving integrally with the movable weight portion 120 and each facing the fixed electrode portion 150. In FIG. 4, the two capacitors C1 and C2 are formed. When acceleration acts on the movable weight portion 120, the gap between the electrodes in one of the capacitors is decreased to increase the capacitance value of the capacitor, while the gap between the electrodes in the other capacitor is enlarged to decrease the capacitance value of the capacitor.

In FIG. 4, the fixed electrode portions 150 are connected to a reference potential (for example, ground potential). Voltages VQ1 and VQ2 of the movable electrode portions 140 are transmitted to the integrated circuit portion 20 through lead wires L1 and L2. In the integrated circuit portion 20, the C/V conversion circuit including the charge amplifier is disposed. Here, the movable electrode portions 140 can be connected to a reference potential, and the voltages of the fixed electrode portions 150 can be transmitted to the integrated circuit portion 20. Also, a capacitor in which the facing area of facing electrodes is changed by applying acceleration can be used.

As shown in FIG. 5, both the movable electrode portion 140 and the fixed electrode portion 150 have a width W. The width W is about 3 μm, for example. A length L is about 100 μm. A gap G between the electrodes during rest is about 1 μm. In FIG. 5, the width of the elastic deformable portion 130 is also set to W.

The movable weight portion 120 that can move within the hollow portions 111 inside the fixed frame portion 110 has a predetermined mass. For example, when acceleration acts on the movable weight portion 120 in a state where the movable weight portion 120 is stopped, force due to the acceleration acts on the movable weight portion 120 to move the movable weight portion 120.

As shown in FIG. 6, the movable weight portion 120 has the second movable weight portion 120B formed of the material of the substrate 101, that is, silicon and the first movable weight portion 120A as the stacked structure formed also by using the manufacturing process of the integrated circuit portion 20 on the second movable weight portion 120B. The stacked structure is formed not only in the movable electrode portion 140 but also similarly in the fixed electrode portion 150, the fixed frame portion 110, and the elastic deformable portion 130 also by using the manufacturing process of the integrated circuit portion 20.

For example, the two movable electrode portions 140 and 140 that protrude from the movable weight portion 120 toward the hollow portions 111 and have the width W (refer to FIG. 5) is formed only of the stacked structure of the first movable weight portion 120A portion (that is, only the first movable electrode portion 140A of FIG. 1) as shown in FIG. 6, and have no portion formed of the substrate material. In FIG. 6, reference numeral 111 denotes the first hollow portions formed by anisotropically etching the stacked structure (reference numeral 113 in FIG. 5 also denotes the first hollow portions). Reference numeral 112 denotes second hollow portions formed by selectively processing the substrate 101 by etching or the like. Reference numeral 102 denotes the recess formed previously on the back surface of the substrate 101. The recess 102 has the depth D. The second hollow portion 112 in communication with the first hollow portion 111 is disposed below the movable electrode portion 140 (the first movable electrode portion 140A formed of the stacked structure). The recess 102 is communicated with the second hollow portions 112.

The same applies to the two fixed electrode portions 150 and 150 that protrude from the fixed frame portion 110 toward the first hollow portions 111. Between the silicon substrate 101 and the stacked structure formed thereon that form the fixed frame portion 110, only the stacked structure protrudes to the first hollow portion 111 side. The second hollow portion 112 in communication with the first hollow portion 111 and the recess 102 is also arranged below the fixed electrode portion 150.

For movably supporting the movable weight portion 120 in a region where the hollow portions 111 and 112 and the recess 102 are respectively assured on the sides of and below the movable weight portion 120, the elastic deformable portions 130 are disposed. The elastic deformable portion 130 is intervened between the fixed frame portion 110 and the movable weight portion 120.

The elastic deformable portion (spring portion) 130 is elastically deformable so as to allow the movable weight portion 120 to move in a weight movable direction in FIG. 4. As shown in FIG. 4, the elastic deformable portion 130 is formed in a loop shape so as to substantially have a constant line width (for example, W) in a plain view and coupled to the fixed frame portion 110. Since the first hollow portions 111 and 113 are formed around the elastic deformable portion 130, elastic deformability in the air is secured for the elastic deformable portion 130.

As shown in FIG. 7 which is the B-B cross section of FIG. 5, the elastic deformable portion 130 is formed of the stacked structure formed also by using the forming process of the integrated circuit portion 20 in the same manner as the movable weight portion 120. The second hollow portion 112 is also formed below the elastic deformable portion 130. The first hollow portions 111 and 113 are communicated with the second hollow portion 112 and the recess 102.

The embodiment is directed to the electrostatic capacitive acceleration sensor, which has the movable electrode portion 140 and the fixed electrode portion 150 in which the gap between the facing electrodes is changed by the action of acceleration. The movable electrode portion 140 is integrated with the movable weight portion 120. The fixed electrode portion 150 is integrated with the fixed frame portion 110. The movable electrode portion 140 and the fixed electrode portion 150 are formed also by using the forming process of the integrated circuit portion 20 in the same manner as the movable weight portion 120.

### Configuration of Integrated Circuit Portion

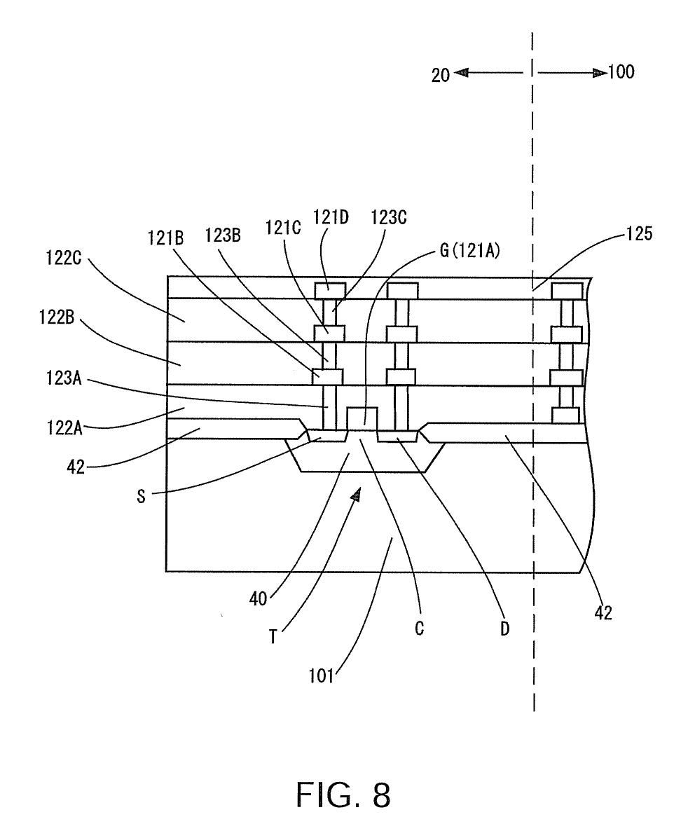

FIG. 8 shows a cross-sectional structure of the integrated circuit portion 20. The CMOS integrated circuit portion 20 shown in FIG. 8 is manufactured by a well-known process. A well 40 different in polarity from the silicon substrate 101 is formed in a substrate, for example, the silicon substrate 101. In the well 40, a source S, a drain D, and a channel C are formed. A gate electrode G is formed above the channel C via a gate oxide film (not illustrated). The same layer as the gate G is defined as a conductive layer 121A. In a field region for device isolation and the region of the acceleration sensor 100, a thermal oxide film 42 is formed as a field oxide film. In this manner, a transistor T is formed on the silicon substrate 101, and wiring is made for the transistor T, so that the CMOS integrated circuit portion 20 is completed.

In the embodiment, therefore, with the conductive layer 121A and conductive layers 121B to 121D, four in total including the same layer as the gate G, inter-layer insulating layers 122A to 122C, and plugs 123A to 123C, wiring can be made for the source S, drain D, and gate G of the transistor T (wiring of the gate G is not illustrated).

### Structure Example of Stacked Structure

As shown in FIG. 6, by using the plurality of conductive layers 121A to 121D, the plurality of inter-layer insulating layers 122A to 122C, the plurality of plugs 123A to 123C, an insulating layer 124 (including the thermal oxide film 42), and a protective layer 125, necessary for forming the CMOS integrated circuit portion 20, the stacked structure of the acceleration sensor 100 can be formed.

As shown in FIG. 6 which is the A-A cross-sectional view of FIG. 5, the stacked structure of the movable weight portion 120 (the first movable weight portion 120A) can be basically configured only by the plurality of insulating layers (that is, the insulating layer (surface protective layer) 124 disposed on the surface of the silicon substrate, the inter-layer insulating layers 122A to 122C, and the protective layer 125). However, since the movable electrode portion 140 needs to be electrically connected to the integrated circuit portion 20, wiring using a conductive material layer (wiring having a three-dimensional cross section is applicable) needs to be installed to a path reaching the fixed frame portion 110 side through the movable weight portion 120 and the elastic deformable portion 130. Accordingly, a conductive layer needs to be actually arranged in at least apart of the movable weight portion 120. For increasing the mass of the movable weight portion 120, electrically floating conductive layer and plug (that is, a conductive material layer that is independent of other wiring and used only for making the mass M of the movable weight portion 120 heavier) can be arranged (arranged in a cross shape, for example, as described above).

On the other hand, it is necessary to actively arrange a conductive layer and a plug in the movable electrode portion 140 and the fixed electrode portion 150 for securing the function as an electrode. Therefore, in the movable electrode portion 140 and the fixed electrode portion 150, as shown in FIGS. 6 and 7, the plurality of conductive layers 121A to 121D, the plurality of inter-layer insulating layers 122A to 122C arranged between the respective plurality of conductive layers 121A to 121D, and the plugs 123A to 123C filled into the predetermined embedding groove patterns formed through the respective plurality of inter-layer insulating layers 122A to 122C are arranged. The insulating layer 124 below the conductive layer (for example, polysilicon layer or the like) 121A in the lowermost layer corresponds to the gate oxide film (not shown) and thermal oxide film 42.

In this case, in the movable electrode portion 140 and the fixed electrode portion 150, the plugs 123A to 123C formed in the respective layers include the wall portions formed in a wall shape along the longitudinal direction in which each electrode portion protrudes toward the hollow portion 111. In a typical IC, since a plug is only aimed at connecting upper and lower wiring layers to each other, the plug has a columnar shape or a prismatic shape. In the embodiment, on the other hand, the plugs 123A to 123C are used for the purpose of enlarging the facing electrode surfaces of the movable electrode portion 140 and the fixed electrode portion 150, or for the purpose of increasing the mass M of the movable weight portion 120. Therefore, the shape thereof is apparently different from that of a typical plug.

Meanwhile, the elastic deformable portion 130 is entirely formed of insulating layers except for the conductive layer 121D in the uppermost layer as shown in FIG. 7. However, this configuration is an example. In the elastic deformable portion 130, the structure in which the conductive layers that are in different layers are connected to one another with plugs can be adopted. For adjusting a spring constant K to a desired design value, it is effective to change the arrangement or number of conductive layers or plugs. Moreover, the lead wires (L1 and L2 in FIG. 4) for transmitting the voltage of the movable electrode portion 140 to the integrated circuit portion 20 need to be installed in the elastic deformable portion 130. In the example of FIG. 7, the conductive layer 121D corresponds to the wire L1 (L2). However, the wire L1 (L2) is not necessarily the conductive layer in the uppermost layer, but a conductive layer in another layer can be used as a wire.

### Third Embodiment

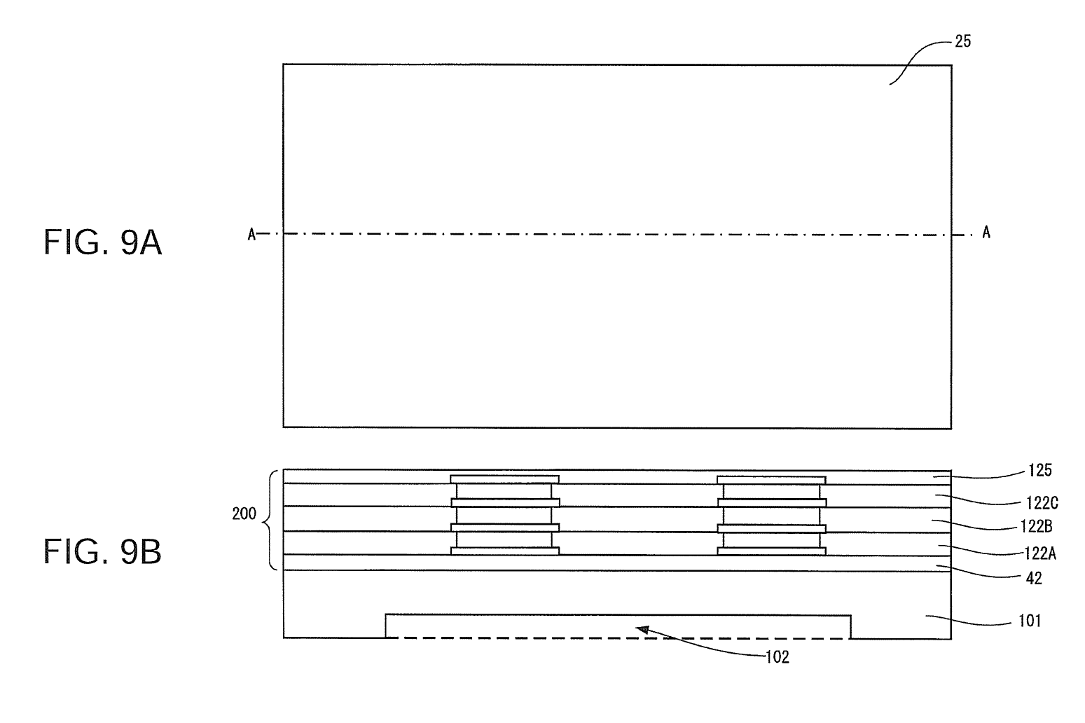

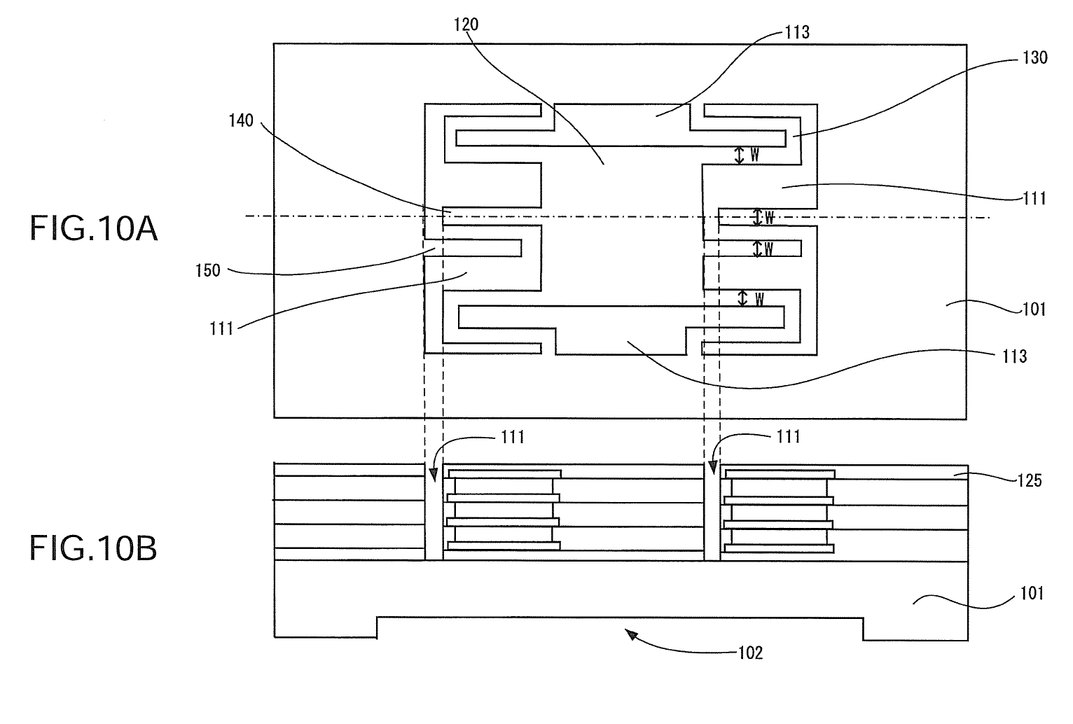

In a third embodiment, an exemplary method for manufacturing the capacitive MEMS acceleration sensor will be described. Hereinafter, a method for manufacturing the acceleration sensor module 10 shown in FIG. 4 will be schematically described with reference to FIGS. 9A and 9B to 13. As shown in FIG. 9B, with the silicon substrate 101 alone, the recess 102 is first formed in advance on the back surface of the silicon substrate 101. Next as shown in FIGS. 10A and 10B, a stacked structure 200 is formed on the silicon substrate 101 having the recess 102 formed on the back surface.

The recess 102 formed on the back surface of the silicon substrate 101 is not necessarily required. When the silicon substrate 101 originally has an appropriate thickness, the recess 102 is not required. However, since it is actually difficult in most cases to adjust the thickness of the silicon substrate 101 in accordance with the design value of the acceleration sensor, it is preferable to dispose the recess 102. As shown in FIG. 6, when the recess 102 is present, a leg portion having a level difference by the amount of the depth D of the recess 102 can be formed. Accordingly, the movable weight portion 120 is not in contact with a placing surface, which is preferable.

Among the processes for manufacturing the acceleration sensor 100 by using the manufacturing process of the integrated circuit portion 20, the forming process of the conductive layers 121A to 121C and the plugs 123A to 123C will be briefly described. The forming step of the first conductive layer 121A is carried out simultaneously with the forming step of the gate G shown in FIG. 8. In the embodiment, a polysilicon layer Poly-Si is formed to a thickness of from 100 to 5000 angstrom by chemical vapor deposition (CVD) and pattern etched by a photolithography step to form the first conductive layer 121A. The first conductive layer 121A can be formed of silicide or a high-melting-point metal in addition to polysilicon.

The forming step of the first plug 123A is carried out simultaneously with a gate contact step in the integrated circuit portion 20. In the embodiment, a material such as, for example, NSG, BPSG, SOG, or TEOS is formed to a thickness of from 10000 to 20000 angstrom by CVD to form the first inter-layer insulating layer 122A. Thereafter, the first inter-layer insulating layer 122A is pattern etched by using a photolithography step to form a predetermined embedding groove pattern in which the first plug 123A is embedded and formed. A material such as W, TiW, or TiN is embedded in the embedding groove pattern by sputtering, CVD, or the like. Thereafter, the conductive layer material on the first inter-layer insulating layer 122A is removed by etching back or the like to complete the first plug 123A.

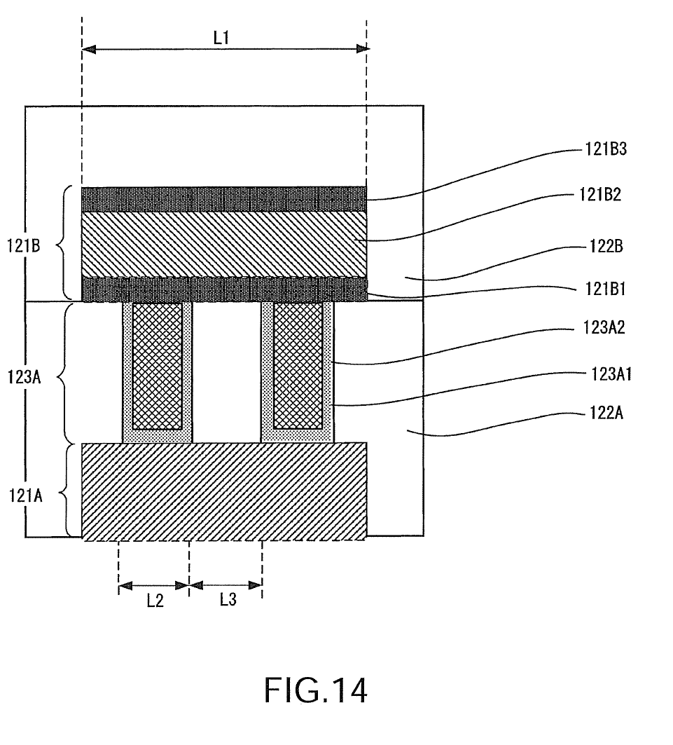

FIG. 14 shows a cross-sectional structure of the conductive layers and plugs. As shown in FIG. 14, while the first conductive layer 121A has a width L1 (for example, L1=2 μm), the two first plugs 123A each having a width L2 (for example, L2=0.5 μm) are arranged with a gap L3 (for example, L3=0.5 μm).

In FIG. 14, an example of the material of the first plug 123A is also shown. A material such as, for example, W, Cu, or Al can be used as a contact plug 123A1. A material such as, for example, Ti or TiN can be used as a barrier layer 123A2 covering the periphery of the contact plug 123A1. The contact plug 123A1 can be formed to a thickness of from 5000 to 10000 angstrom by sputtering or CVD. Also the barrier layer 123A2 can be formed to a thickness of from 100 to 1000 angstrom by sputtering or CVD.

The forming step of the second conductive layer 121B is carried out simultaneously with the forming step of a first metal wiring layer of the integrated circuit portion 20. The second conductive layer 121B can be formed as a multi-layer structure in which Ti, TiN, TiW, TaN, WN, VN, ZrN, NbN, or the like is used as a barrier layer 121B1, Al, Cu, an Al alloy, Mo, Ti, Pt, or the like is used as a metal layer 121B2, and TiN, Ti, amorphous Si, or the like is used as an antireflection layer 121B3. The same materials as the second conductive layer 121B can be used also for forming the third and fourth conductive layers 121C and 121D. The barrier layer 122B1 can be formed to a thickness of from 100 to 1000 angstrom by sputtering. The metal layer 121B2 can be formed to a thickness of from 5000 to 10000 angstrom by sputtering, vacuum deposition, or CVD. The antireflection layer 121B3 can be formed to a thickness of from 100 to 1000 angstrom by sputtering or CVD.

By depositing PSiN, SiN, SiO₂, or the like to a thickness of from 5000 to 20000 angstrom by CVD, the protective layer 125 is formed on the entire surface.

Next, in the step of FIGS. 10A and 10B, holes penetrating from the surface of the protective layer 125 to the surface of the silicon substrate 101 are formed. In this manner, the first hollow portions 111 and 113 are formed. Therefore, the inter-layer insulating layers 122A to 122C, the insulating layer 124, and the protective layer 125 are etched. The etching step is insulating film anisotropic etching in which the ratio (H/D) of an etching depth (for example, 4 to 6 μm) to an opening diameter D (for example, 1 μm) is a high aspect ratio. With this etching, the fixed frame portion 110, the movable weight portion 120, and the elastic deformable portion 130 can be separated from one another. The anisotropic etching is preferably performed by using the conditions for etching a typical inter-layer insulating film between CMOS wiring layers. The processing can be carried out by performing dry etching using, for example, a mixed gas of CF₄, CHF₃, and the like.

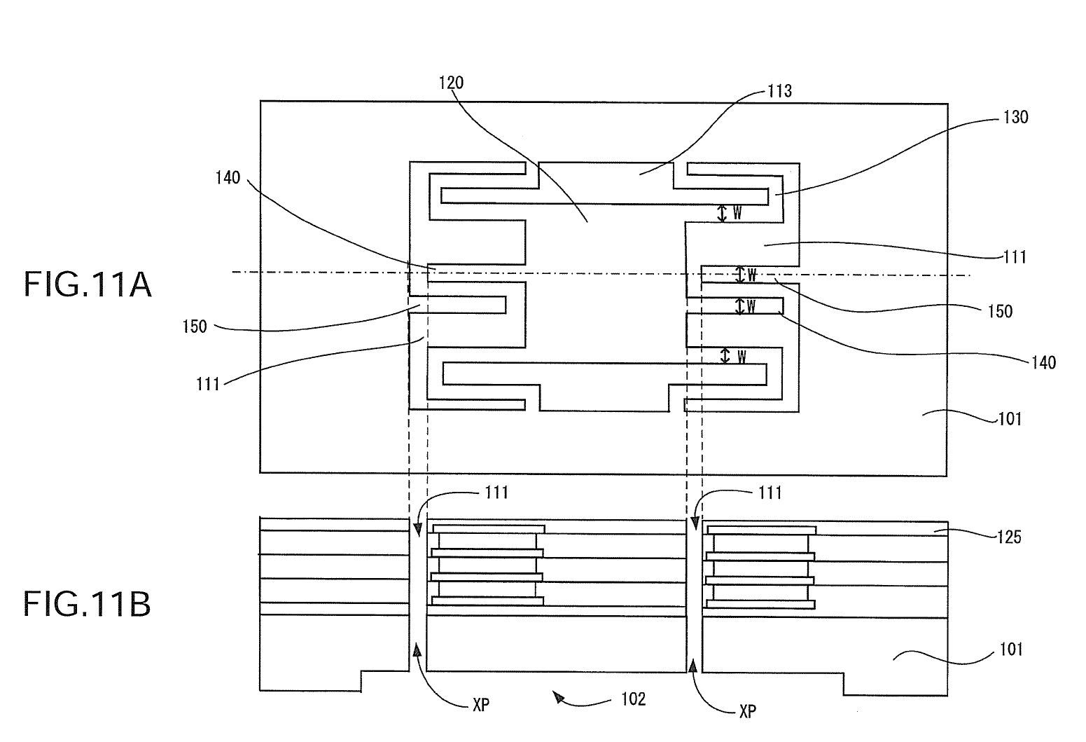

FIGS. 11A and 11B explain an anisotropic etching step for the silicon substrate. In FIGS. 11A and 11B, by allowing an etchant to reach the surface of the silicon substrate via the first hollow portions 111 and 113 disposed in the step of FIGS. 10A and 10B, anisotropic etching for the silicon substrate is performed. When the depth of the etching reaches the back surface of the silicon substrate 101, through holes XP are formed through the silicon substrate.

As the above-described anisotropic etching method for the silicon substrate 101, a method can be used in which etching is performed while forming a side wall protective film, for example. As an example, an etching method using inductively coupled plasma (ICP) disclosed in JP-T-2003-505869 can be adopted. In this method, a passivation step (side wall protective film formation) and an etching step are repeatedly carried out, a protective film is formed on the side wall of a hole formed by etching, and anisotropic etching is performed only in a depth direction while preventing isotropic etching with the protective film. As the etching conditions in the passivation step, C₄F₈, C₃F₆, or the like may be used as an etching gas under a process pressure of 5μ to 20 μbar and an average input coupled plasma power of 300 to 1000 W. As the etching conditions in the etching step, SF₆, CIF₃, or the like may be used as an etching gas under a process pressure of 30μ to 50 μbar and an average input coupled plasma power of 1000 to 5000 W. In addition, reactive ion etching (RIE) can be used for forming the side wall protective film.

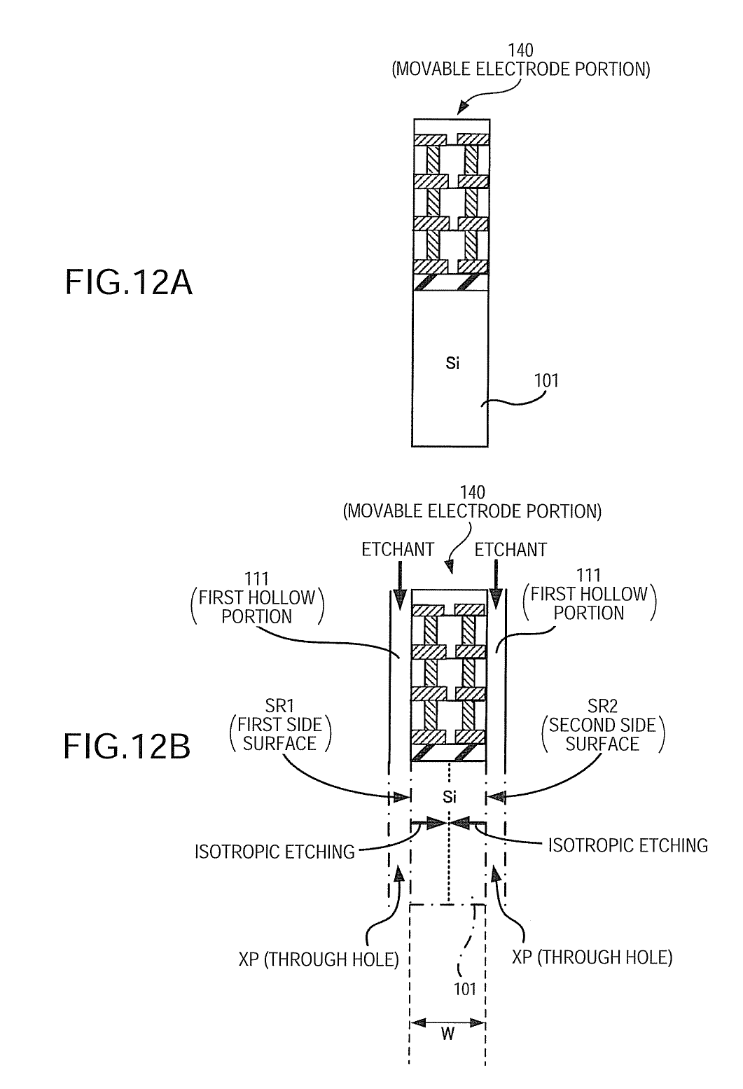

Next as shown in FIGS. 12A and 12B, an etchant for isotropic etching is introduced via the through holes XP formed by anisotropically etching the silicon substrate 101, the side surface portions of the silicon substrate 101 exposed to the through holes XP are isotropically etched from both sides. FIG. 12A shows a cross-sectional structure of the movable electrode portion 140. FIG. 12B shows a state of the isotropic etching. As shown in FIG. 12B, the silicon substrate 101 below the movable electrode portion 140 is etched inwardly from both side surfaces SR1 and SR2 exposed to the through holes XP. The lateral width W of the movable electrode portion 140 is set so as to satisfy a relation of 2·X(t)≧W where t is an etching time, and X(t) is an etching rate per etching time t. Accordingly, with the elapse of the etching time t, the silicon substrate 101 below the movable electrode portion 140 is completely removed.

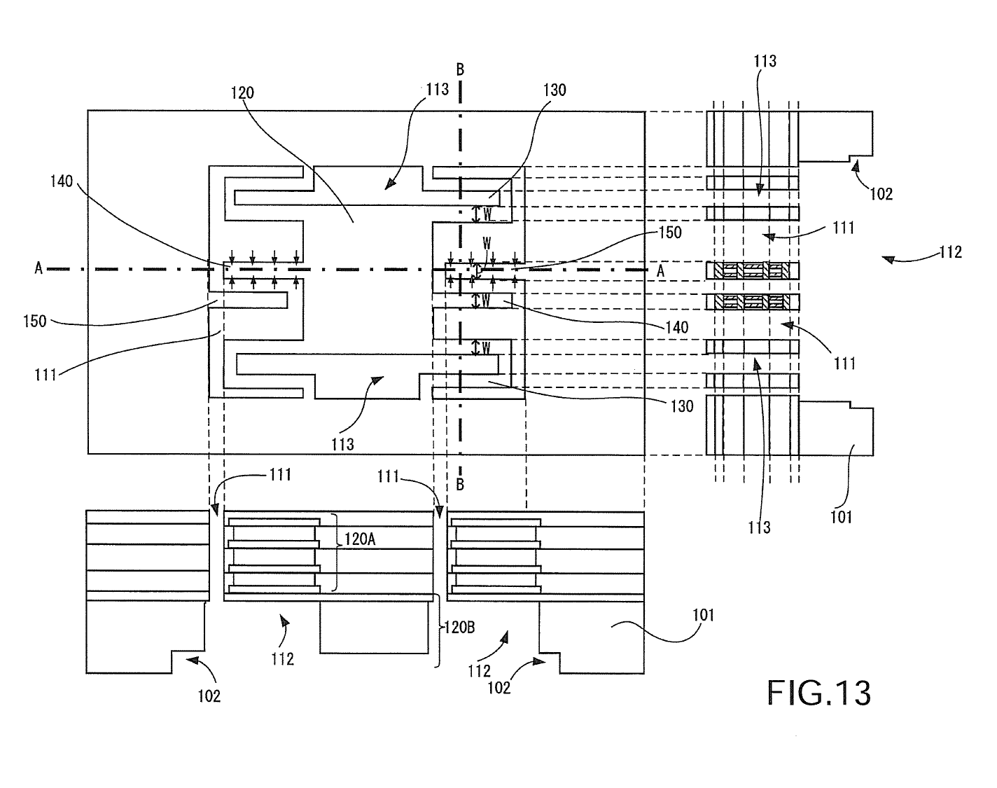

As a result, a cross-sectional structure shown in FIG. 13 is obtained. In FIG. 13, in the movable electrode portion 140 or the fixed electrode portion 150 protrudingly formed toward the first hollow portion 111, a plurality of arrows are shown. These arrows show that the silicon substrate positioned below the electrode portion (width W) protrudingly formed toward the first hollow portion 111 is isotropically etched simultaneously from both side surfaces of the protruded portion. That is, with the elapse of a predetermined time after starting isotropic etching, the silicon substrate 101 below the pair of the movable electrode portion 140 and the fixed electrode portion 150 (that is, the silicon substrate 101 below the comb-shaped electrode portion) is removed. As shown in FIGS. 10A and 10B or 11A and 11B in this case, the width of the layout pattern of the elastic deformable portion 130 is set to the same as that of the electrode portion (that is, width W). Therefore, the silicon substrate below a first elastic deformable portion 130A formed of the stacked structure is also removed simultaneously in the same manner. As a result, the MEMS acceleration sensor shown in FIG. 1 is configured.

In the isotropic etching of the silicon substrate below the comb-shaped electrode, etching is performed only in a width direction of the electrode portion. Therefore, when the width W of the comb-shaped electrode is 3 μm for example, the silicon substrate is completely removed (refer to FIG. 12B) by etching the silicon substrate from the both side surfaces by 1.5 μm. Accordingly, the etching time is shortened.

Specifically, as the method for isotropically etching the silicon substrate 101, a method of introducing an etching gas XeF₂ to a wafer disposed in an etching chamber can be adopted, for example. The etching gas needs not to be plasma excited, so that gas etching is possible. As disclosed in JP-A-2002-113700 for example, an etching process at a pressure of 5 kPa can be performed with XeF₂. Moreover, XeF₂ has a vapor pressure of about 4 Torr, and etching is possible at or below the vapor pressure. Also an etching rate of 3 to 4 μm/min can be expected. In addition, ICP etching can be used. For example, when a mixed gas of SF₆ and O₂ is used, a pressure in the chamber is set to 1 to 100 Pa, and a RF power of about 100 W is supplied, etching of 2 to 3 μm is completed in several minutes.

### Fifth Embodiment

In a fifth embodiment, the silicon substrate member is left also in the elastic deformable portion 130 to suppress the distortion or the like of the elastic deformable portion 130.

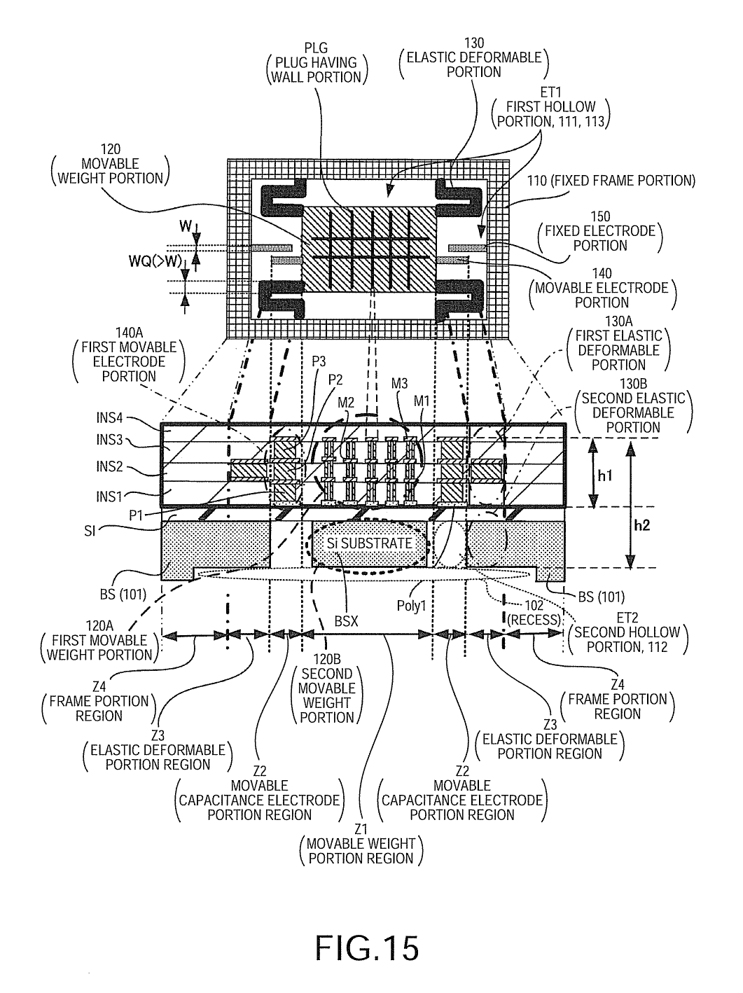

FIG. 15 shows a planar shape and a cross-sectional structure of another exemplary MEMS sensor of the invention (example in which the MEMS sensor has a second movable weight portion and a second elastic deformable portion that are formed of a part of the silicon substrate, and the substrate is processed by using, for example, isotropic etching).

In the cross-sectional structure of FIG. 15, the elastic deformable portion 130 has the first elastic deformable portion 130A formed of the stacked structure and a second elastic deformable portion 130B formed of the silicon substrate member. The other portions are the same as those in the cross-sectional structure of FIG. 1. That is, in the cross-sectional structure of FIG. 15, the substrate member is disposed in the movable weight portion 120 and the elastic deformable portion 130 but the substrate material is not disposed in the movable electrode portion 140 and the fixed electrode portion 150.

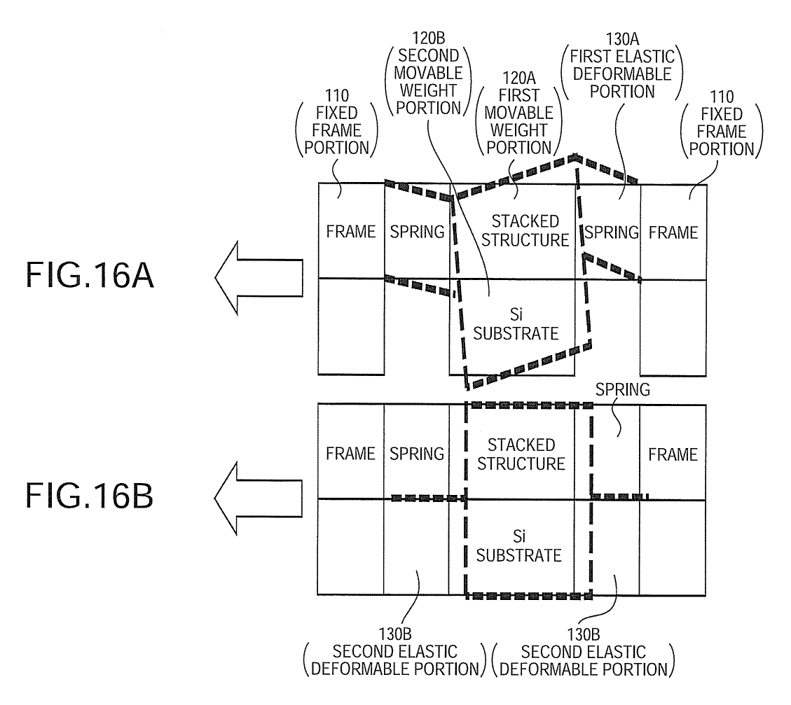

In the elastic deformable portion 130, by disposing the second elastic deformable portion 130B formed of the substrate material, the movement of the elastic deformable portion (spring portion) in the vertical direction (direction perpendicular to the substrate) is restricted. FIGS. 16A and 16B explain an exemplary effect of the second elastic deformable portion 130B. FIG. 16A shows exemplary elastic deformation when the second elastic deformable portion 130B is not disposed. In FIG. 16A, when force due to acceleration is applied in a direction of arrow, the movable weight portion 120 is deformed in some cases in the vertical direction (direction perpendicular to a horizontal plane). This sometimes causes unnecessary movement such as distortion.

FIG. 16B shows exemplary elastic deformation when the second elastic deformable portion (junction portion) 130B is disposed. Since the silicon substrate member (second elastic deformable portion 130B) having high rigidity is formed on the back surface of the first elastic deformable portion 130A, the movement of the first elastic deformable portion 130A formed of the stacked structure is restricted in an unnecessary direction (for example, vertical direction). Accordingly, an effect that the possibility of causing unnecessary movement such as distortion is reduced is provided. Unnecessary deformation in the elastic deformable portion (spring portion) 130 is suppressed, so that the detection sensitivity of the MEMS sensor is further improved.

An effective spring constant is determined by (mechanical spring constant−electronic spring constant). Accordingly, the equation of linear spring characteristics expressed by F=kX (F is force, k is a spring constant, and X is a displacement amount) is not established unless the electronic spring constant is designed so as to be sufficiently smaller than the mechanical spring constant, which is a design restriction. When the second elastic deformable portion is formed, the mechanical spring constant in an elastic member is increased due to the rigidity of the substrate material (for example, silicon), and the electronic spring constant (spring constant due to the Coulomb force) becomes relatively small so as to be negligible. Therefore, the design of the elastic deformable portion (spring portion) is facilitated. In this manner, with the effect of suppressing unnecessary deformation or increasing the mechanical spring constant in the elastic deformable portion (spring portion) for example, the detection sensitivity of the MEMS sensor is further improved.

For obtaining the cross-sectional structure shown in FIG. 15, for example, a lateral width WQ of the elastic deformable portion 130 may be set larger than the lateral width W of the movable electrode portion 140 or the fixed electrode portion 150, and the manufacturing method described in the fourth embodiment may be carried out. With this setting, the substrate 101 below the elastic deformable portion 130 cannot be completely removed by isotropic etching, so that the substrate material can be left below the elastic deformable portion 130. That is, when the substrate 101 below the electrode portion (the movable electrode portion 140 and the fixed electrode portion 150) and the elastic deformable portion 130 is isotropically etched simultaneously from the both side surfaces, the substrate 101 below the electrode portion is completely removed after a predetermined time, but the substrate is left below the elastic deformable portion 130. When the etching is stopped in this state, the substrate below the electrode portion can be completely removed while leaving the substrate material below the elastic deformable portion 130.

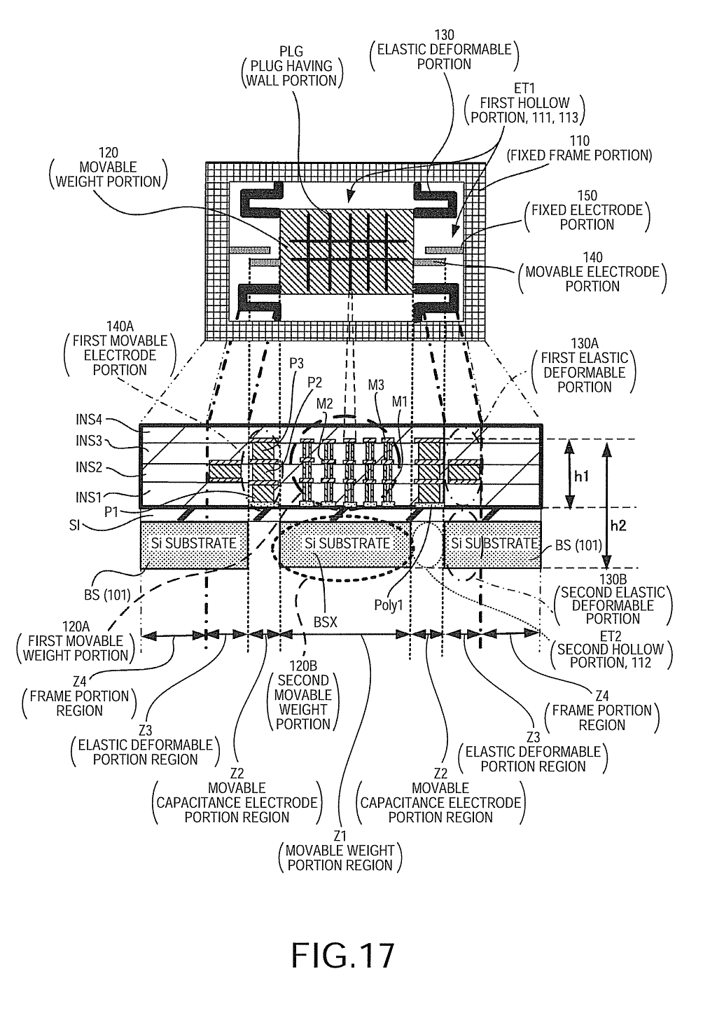

FIG. 17 shows another structure example of the MEMS sensor. Also in FIG. 17, the elastic deformable portion 130 is configured with the first elastic deformable portion 130A and the second elastic deformable portion 130B. In FIG. 17, for example, selective processing (selective patterning) of the substrate is performed before forming the stacked structure.

For example, in the substrate 101 before forming the stacked structure (state where a surface insulating film SI is formed), a method can be adopted in which part of the substrate is removed (however, the surface insulating film SI is left) by performing selective etching (for example, anisotropic wet etching due to alkali etching using KOH or the like, or anisotropic dry etching using an anisotropic etching gas) or the like from the back surface of the substrate to previously form the second hollow portion ET2 (reference numerals 111 and 113 in the embodiment shown before).

### EFFECTS OF EMBODIMENTS

According to the embodiments described above, the degree of design freedom is improved, and the detection sensitivity of physical quantity is also improved. As shown in FIG. 6 for example, when the recess 102 having the depth D is formed, (H1−D) obtained by subtracting the depth D from a thickness H1 of the silicon substrate 101 is a height H2 of the second movable weight portion 120B of the movable weight portion 120. Accordingly, when the thickness H1 of the silicon substrate 101 and the depth D of the recess 102 are determined, the height H2 of the second movable weight portion 120B is automatically determined. On the other hand, since the first movable weight portion 120A coincides with a thickness H3 of the stacked structure 200, the height of the movable weight portion 120 is (H2+H3). Therefore, the height of the movable weight portion 120 is greater than the height H3 of the movable electrode portion 140 by the amount of the second movable weight portion 120B. In FIG. 6, H4 denotes a height of the conductive material portion of the movable electrode portion 140.

Accordingly, the mass M of the movable weight portion 120 is increased by the amount of the second movable weight portion 120B. Here, a sensitivity S is expressed by S=C0/d0·(M/K) [F/(m/sec²)] where C0 is the entire capacitance of the electrode capacitor, K is the spring constant of the elastic deformable portion 130, and d0 is the gap between the electrodes. That is, as the mass of the movable weight portion 120 increases, the sensitivity improves.

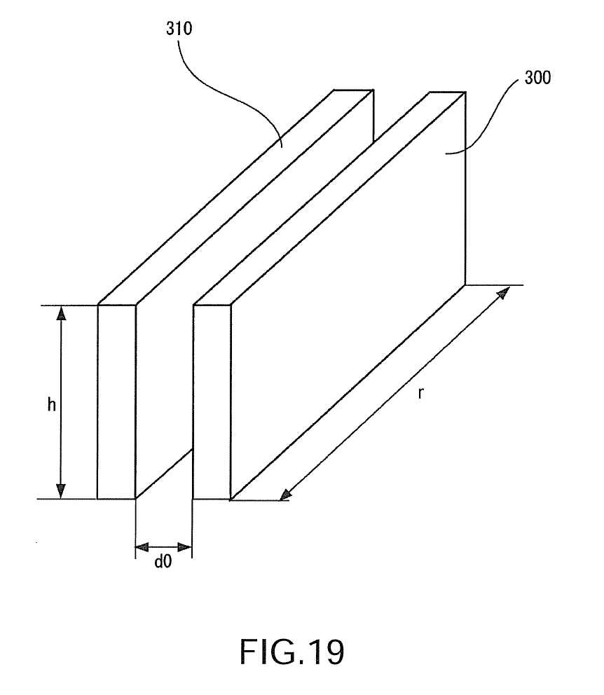

As shown in FIG. 19, in a movable electrode portion 300 and a fixed electrode portion 310 that face each other, the height is defined as h, the length in a lateral direction is defined as r, and the gap between the electrodes is defined as d0. In this case, when the gap of capacitance (distance between the movable electrode portion and the fixed electrode portion) is changed due to the movement of the movable electrode portion, the gas between the electrodes moves vertically. At that time, damping (action to stop the vibration of the movable electrode portion) occurs for the movement of the movable electrode portion due to the viscosity of the gas (air). The damping coefficient D representing the magnitude of damping is expressed by D=n·μ·r(h/d0)³ [N·sec/m] where n is the number of pairs of electrodes, and μ is the viscosity coefficient of the gas. That is, the damping coefficient D increases with the cube of the height h of the electrode portion. Force acts on the movable electrode portion due to the Brownian motion of the gas, which serves as the Brownian noise equivalent acceleration. The Brownian noise (BNEA) is expressed by BNEA=(√(4 kBTD))/M [(m/sec²)/√Hz]. The numerator of the equation is proportional to the square root of the damping coefficient D that is proportional to the cube of the height h of the movable electrode portion. Therefore, even when the mass M increases, the Brownian noise increases in the event.

In the embodiment that solves the above problem, the mass M of the movable weight portion 120 and the height h of the movable electrode portion 140 can be controlled independently of each other. This increases the degree of design freedom, so that a low noise acceleration sensor can be realized.

The capacitive MEMS sensor is a structure expressed by an equation of motion of free vibration with viscous damping (for example, refer to the following equation (1)). Therefore, the Q value and resonant frequency (natural frequency) of the structure needs to be designed to a favorable value. A resonant frequency (natural frequency) ω of the structure that performs free vibration with viscous damping is uniquely determined by the mass M of the movable weight portion and the spring constant K of the spring (elastic deformable portion) supporting the movable weight portion (for example, refer to the following equation (2)). The Q value representing a resonance sharpness is determined by a calculation equation to which the damping constant D is further added (for example, refer to the following equation (3)). In the equation (3), ξ denotes a critical damping coefficient.

$$\begin{matrix}[ su 1 ] & \\ M \ddot{X} + D \dot{X} + KX = 0 & ( 1 ) \\ ω = \sqrt{\frac{K}{M}} & ( 2 ) \\ Q = \frac{1}{2 ξ} = \frac{\sqrt{MK}}{D} & ( 3 )\end{matrix}$$

As is apparent from the equation (3), as the mass M of the movable weight portion increases, the Q value increases. As the damping coefficient D increases, the Q value decreases. When the height of the stacked structure (that is, the height of the movable electrode portion) is simply increased for increasing the Mass M, it is difficult to maintain the Q value at a desired value because the damping coefficient D increases with the cube of the height of the movable electrode portion. According to the embodiments of the invention, the mass M of the movable weight portion and the damping coefficient D in the movable electrode portion can be separately controlled independently of each other. Accordingly, the damping coefficient D of the movable electrode portion can be easily set to an appropriate value while maintaining the Q value at an appropriate value.

By forming the second elastic deformable portion formed of the substrate material, the movement of the first elastic deformable portion formed of the stacked structure in an unnecessary direction (for example, vertical direction) is restricted. Therefore, the possibility of causing unnecessary movement such as distortion is reduced.

Unnecessary deformation in the elastic deformable portion (spring portion) is suppressed, so that the detection sensitivity of the MEMS sensor is further improved.

### Modification of Manufacturing Method

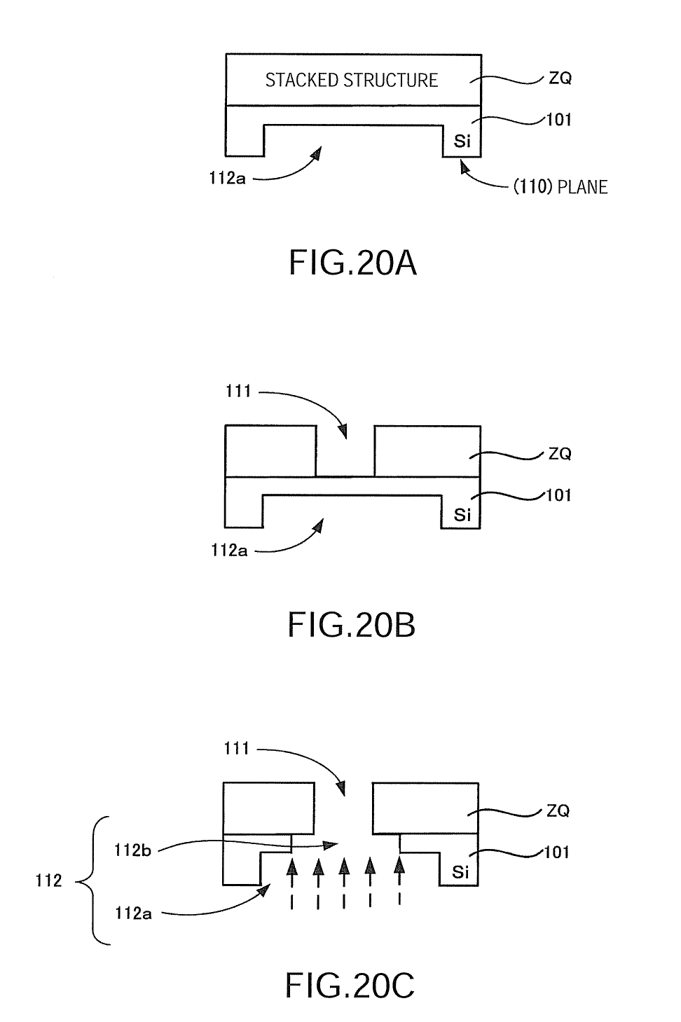

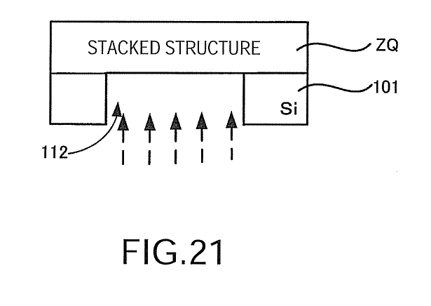

FIGS. 20A to 20C show another exemplary manufacturing method of the MEMS sensor. In FIG. 20A, the crystal plane of the back surface of the silicon substrate 101 opposite to the surface on which a stacked structure ZQ is formed is a (110) plane, and a hollow portion 112a is formed by alkali etching (wet etching) using KOH. In FIG. 20B, the first hollow portion 111 is formed through the stacked structure ZQ by anisotropic dry etching. In FIG. 21C, selective dry etching is carried out from the back surface of the silicon substrate 101 to form a hollow portion 112b. The hollow portions 112a and 112b are in communication with each other, and therefore the second hollow portion 112 is formed. Although the substrate can be processed only by wet etching, both electrodes of the comb electrode portion (both electrodes of capacitor) are sometimes stuck each other, that is, sticking occurs, due to moisture at the time of wet etching. Therefore, dry etching is preferably used for processing the substrate at least in a final stage.

In FIG. 21, the second hollow portion 112 is formed by anisotropic dry etching from the back surface side of the silicon substrate 101.

The embodiments have been described above in detail. However, those skilled in the art should readily understand that many modifications may be made without substantially departing from the novel matter and effects of the invention. Accordingly, those modifications are also included in the scope of the invention. For example, a term described at least once with a different term with a broader sense or the same meaning in the specification or the accompanying drawings can be replaced with the different term in any part of the specification or the accompanying drawings.

For example, the MEMS sensor according to the invention is not necessarily applied to an electrostatic capacitive acceleration sensor but can be applied to a piezo-resistive acceleration sensor. Moreover, the MEMS sensor is applicable as long as the sensor is a physical sensor that detects change in capacitance based on the movement of a movable weight portion. For example, the MEMS sensor can be applied to a gyro sensor, a pressure sensor, or the like.

In the MEMS sensor according to one aspect of the invention, by using the facing electrodes in which the distance therebetween can vary, at least the magnitude of physical quantity can be detected. However, the MEMS sensor cannot detect a direction in which the physical quantity acts. Therefore, the MEMS sensor may have at least one fixed electrode portion and a plurality of movable electrode portions that move in at least a uni-axial direction integrally with a movable weight portion and whose distances relative to at least one fixed electrode portion increase or decrease.

The detecting principle of physical quantity is as follows. When the plurality of movable electrode portions move with the movable weight portion with respect to at least one fixed electrode portion, one of two distances between the electrodes is increased while the other being decreased. Therefore, based on the relation between the magnitude and increase or decrease of the capacitances depending on the distances between the electrodes, the magnitude and direction of the physical quantity can be detected. The detection axis of physical quantity is not restricted to the uni-axial or a bi-axial direction, but a tri- or more multi-axial direction may be adopted. Moreover, a method can be adopted in which a physical quantity is detected based on change in facing area between electrodes of a capacitor.

The present invention is not limited to this; the MEMS sensor also can be used for electronic device such as a digital camera, a car navigation system, a mobile phone, a mobile personal computer, a game controller. According to this structure, it is able to improve detection sensitivity by the MEMS sensor.

The entire disclosure of Japanese Patent Application No. 2009-075902, filed Mar. 26, 2009 and No. 2010-058817, filed Mar. 16, 2010 are expressly incorporated by reference herein.

What is claimed is:

1. A MEMS sensor comprising:
a support portion;
a movable weight portion;
a connection portion connecting the support portion and the movable weight portion, is possible an elastic deformation;
a fixed electrode portion extending from the support portion; and
a movable electrode portion extending from the movable weight portion and disposed opposed to the fixed electrode portion, wherein
the movable weight portion includes a first movable weight portion and a second movable weight portion positioned below the first movable weight portion.

2. The MEMS sensor according to claim 1, wherein
the first movable weight portion is a laminated layer structure having a conductive layer and an insulated layer.

3. The MEMS sensor according to claim 2, wherein
the connection portion, the fixed electrode portion, and the movable electrode portion are formed by the use of the laminated layer structure.

4. The MEMS sensor according to claim 2, wherein
the insulated layer is embedded a plug, and the plug has specific gravity larger than that of the insulated layer.

5. The MEMS sensor according to claim 1, wherein
the second movable weight portion is a single layer substrate.

6. The MEMS sensor according to claim 1, wherein
the thickness of added the first movable weight portion and the second movable weight portion is larger than that of the movable electrode portion.

7. The MEMS sensor according to claim 1, wherein
the support portion is formed on a base portion,
the base portion is used the same material as the second movable weight portion,
a through hole is formed between the base portion and the second movable weight portion.

8. The MEMS sensor according to claim 7, wherein
a junction portion is formed between the second movable weight portion and the base portion, connect the second movable weight portion and the base portion,
the connection portion is formed on the junction portion.

9. The MEMS sensor according to claim 7, wherein
the thickness of at least partly the base portion is larger than that of the second movable weight portion.

10. The MEMS sensor according to claim 1, further comprising an integrated circuit portion formed adjacent to the support portion.

11. An electronic device comprising the MEMS sensor according to claim 1.

12. A MEMS sensor manufacturing method for a MEMS sensor having a support portion; a movable weight portion; a connection portion connecting the support portion and the movable weight portion, is possible an elastic deformation; a fixed electrode portion extending from the support portion; and a movable electrode portion extending from the movable weight portion and disposed opposed to the fixed electrode portion, comprising:
first process forming a laminated layer structure on a first plane of a substrate;
second process forming a hole penetrating from a top layer of the laminated layer structure to the substrate, by anisotropic etching;
third process removing the substrate positioned below the fixed electrode portion and the movable electrode portion, by isotropically etching.

13. The method for manufacturing the MEMS sensor according to claim 12, further comprising forming a recess on a second plane as the opposite side of the first plane.
